(19) United States
(12) Patent Application Publication
(10) Pub. No.: US 2024/0394422 A1
(43) Pub. Date: Nov. 28, 2024

(54) SYSTEM AND METHOD FOR GENERATING INTELLIGENT VIRTUAL REPRESENTATIONS OF ARCHITECTURE, ENGINEERING, AND CONSTRUCTION (AEC) CONSTRUCTS

(71) Applicant: Slate Technologies Inc., Pleasanton, CA (US)

(72) Inventor: Senthil Manickavasagam Kumar, Dublin, CA (US)

(21) Appl. No.: 18/672,340

(22) Filed: May 23, 2024

Related U.S. Application Data
(60) Provisional application No. 63/468,590, filed on May 24, 2023.

(51) Int. Cl. G06F 30/12; G06F 30/27; G06F 111/18

(52) U.S. Cl. CPC G06F 30/12; G06F 30/27; G06F 2111/18

(57) ABSTRACT

A system for generating virtual representations of architecture, engineering, and construction (AEC) smart constructs is disclosed. The system includes a controller that determines user intent based on an analysis of a user input and further determines project objective constraints based on an evaluation of project objectives. Knowledge units are computed based on a plurality of nodes and a plurality of interdependencies of a computational graph. The plurality of nodes corresponds to the user intent, and the plurality of interdependencies is established based on the project objectives. Based on the knowledge units, computational simulations for the user intent are performed. Further, virtual representations of the AEC smart constructs in a digital environment are generated based on the computational simulations. The computational simulations meet a defined criteria associated with the project objectives.

### RELATED APPLICATIONS

This application claims the benefit under 35 U.S.C. § 119 (e) of provisional application 63/468,590, titled “System and method for intelligent creation, management, and execution of Architecture, Engineering, and Construction (AEC) smart constructs,” filed on May 24, 2023, the entire contents of which is hereby incorporated by reference for all purposes as if fully set forth herein.

### FIELD OF THE INVENTION

The present disclosure relates generally to Artificial Intelligence (AI) and machine learning (ML)-based systems. In particular, the disclosure relates to the implementation and use of machine intelligence, smart knowledge assembly, AI, ML, and cognitive systems and methods for intelligent creation, management, and execution of AEC smart constructs in a construction environment. The present disclosure also relates to AI driven Computer Aided Design (CAD), Computer Aided Manufacturing (CAM), and general construction artifacts or assemblies for construction projects.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In the Architecture, Engineering, and Construction (AEC) field, management of projects has always been a complex and multi-layered set of tasks. The AEC field involves selecting and optimizing, by a machine and/or a human, a number of variables that impact cost, construction schedule, quality, and the like, of construction projects. Such variables are able to include, but are not limited to, nature of building to be constructed, the geo attributes of the locale, the topology of the region, nature of craftsmanship required, the design intent and the virtual architectural design, quality of the materials to be used in the construction projects, data and its types to be considered when designing and constructing the construction projects, virtual designs of the construction projects and their selection, types of materials to be used in the construction projects, availability of materials to be used in the construction projects, cost of materials to be used in the construction projects, timelines, understanding and adherence to regulatory processes, environmental factors, quantity and quality of workers required for the construction projects, and many more. For the selection and optimization of such variables, various software and manual solutions are being used at every step or stage of a construction project, such as planning, specific training on aspects related to the variables, designing, and actual construction. In an example, while making virtual designs for the construction projects, such conventional software solutions may require some form of data (in an example, 2D or 3D drawings, or pre-written code) for finalizing the designs.

Conventional software solutions in the AEC field rely on manual and rule-based approaches for generating specific scenario-based outcomes. However, these software solutions fail to comprehend inputs or dynamic variations and may fail to provide any meaningful insights or action guidance. In addition, there is no follow-up action and validation of whether the guidance was beneficial or not. This problem is aggravated in the AEC field because factors that impact the construction schedule are many and varied. Such problems, while known, are near impractical to predict, plan and accommodate until the factors come to pass or are likely to come to pass with some degree of certainty.

Further, such conventional software solutions are unable to adapt or make decisions in real-time or near real-time to account for the dynamic nature of a construction project when confronted with a multitude and diverse inputs. Conventional software solutions face such challenges as they operate in isolated frameworks and are restricted to accepting inputs of certain types, such as a standard preset set of queries.

Additionally, such conventional software solutions fail to ascertain prior knowledge of the projects and sufficient understanding of the various aspects (related to the construction projects) to comprehend and interpret the metrics (such as project metrics and productivity metrics) and visual artifacts presented in the dashboard, number of employees on site based on trade, contractors, employees, number of incidents, any accidents on the site, monetary implications of certain events, financials, budget and spend, and any other impediments in the construction projects.

Furthermore, conventional software solutions do not offer systems that understand observations related to a construction project that are required to determine any potential impacts of the observations on the overall construction project progress or past experiences translated to understanding of a computational machine.

### SUMMARY OF THE INVENTION

In some embodiments, systems that provide intelligence aided solutions for creation of strategies, design, and design formulation, for construction projects, are described. The executable and operational systems (and their associated subsystems) improve efficiency in construction of buildings and related structures.

The following represents a summary of some embodiments of the present disclosure to provide a basic understanding of various aspects of the disclosed herein. This summary is not an extensive overview of the present disclosure. It is not intended to identify key or critical elements of the present disclosure or to delineate the scope of the present disclosure. Its sole purpose is to present some embodiments of the present disclosure in a simplified form as a prelude to the more detailed description that is presented below. Embodiments of an AI-based system and a corresponding method are disclosed that address at least some of the above-described challenges and issues.

Embodiments of an AI-based system and a corresponding method are disclosed that address at least some of the above challenges and issues. In some embodiments, the subject matter of the present disclosure is a system for generating virtual representations of AEC smart constructs. The system comprises a controller in a computing device to: determine user intent based on an analysis of a user input; determine one or more project objective constraints based on an evaluation of one or more project objectives; compute knowledge units based on a plurality of nodes and a plurality of interdependencies of a computational graph, wherein the plurality of nodes corresponds to one or more of the user intent and the one or more project objectives, and wherein the plurality of interdependencies is established between the plurality of nodes based on the one or more project objective constraints; perform one or more computational simulations for the user intent based on the knowledge units; and generate one or more virtual representations of the AEC smart constructs in a digital environment based on the one or more computational simulations, wherein the one or more computational simulations meet a defined criteria associated with the one or more project objectives.

In some embodiments of the present disclosure, the controller is further configured to: train a machine learning model using training data, wherein the training data comprises historical data, factual data, and human cognitive factors associated with the user and the AEC smart constructs; and apply the trained machine learning model to the user input received from the user for the inference of the user intent for executing at least one intended task by the user, wherein the user intent is classified as at least one of: a design intent, a temporal intent, a spatial intent, a geometrical intent, and a cultural intent.

In some embodiments of the present disclosure, to train the machine learning model, the controller is further configured to: apply one or more logical rules to the user input; and evaluate and analyze new information based on the application of the one or more logical rules to the user input.

In some embodiments of the present disclosure, the controller is further configured to generate a first set of data for the AEC smart constructs based on the inferred user intent, wherein the first set of data comprises taxonomies, intent derivatives, spatial models, geometry computations, temporal computations, and object definitions for the AEC smart constructs.

In some embodiments of the present disclosure, the controller is further configured to generate a second set of data for the AEC smart constructs based on the first set of data, wherein the second set of data comprises objective evaluations, system inputs, correlation maps, sequence compositions, comparative pairings, and knowledge assemblies related to the AEC smart constructs.

In some embodiments of the present disclosure, based on the second set of data, the controller is further configured to generate the one or more virtual representations that corresponds to one or more of a visual composite of a virtual representation, a non-visual composite of the virtual representation, a scenario play and validation of the virtual representation, responses to queries, a human query interface, an operational interface, a speech, a text or a touch gestures, and a computational and physical action.

In some embodiments of the present disclosure, the controller is further configured to perform efficiency monitoring related to the generated virtual representation of the AEC smart constructs.

In some embodiments of the present disclosure, the controller is further configured to present the monitored efficiency of the one or more virtual representations of the AEC smart constructs on a visual display with one or more parameters that are within predefined ranges.

In some embodiments of the present disclosure, the controller is further configured to test operations of the generated virtual representation of the AEC smart constructs in the operational mode in a virtual reality or an augmented reality environment.

In some embodiments of the present disclosure, the controller is further configured to generate one or more recommendations based on at least the user input, the inferred user intent, specifications of a facility for which AEC smart constructs are generated, and the defined criteria associated with the one or more project objectives, wherein the defined criteria associated with the one or more project objectives correspond to cost, time, material, labor, and sustainability associated with a construction project for which the AEC smart constructs are generated.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Further advantages of the invention will become apparent by reference to the detailed description of disclosed embodiments when considered in conjunction with the drawings:

FIG. 1 illustrates an example networked computing system for intelligent generation of virtual representations of AEC smart constructs, according to some embodiments.

FIG. 2A illustrates an example system for intelligent generation of virtual representations of AEC smart constructs, according to some embodiments.

FIG. 2B illustrates an example computational system for implementing the disclosed system, according to some embodiments.

FIG. 3A illustrates example computational graphs for implementing the disclosed system, according to some embodiments.

FIG. 3B illustrates an example intent inference engine for implementing the disclosed system, according to some embodiments.

FIG. 3C illustrates an example generative AI model for implementing the disclosed system, according to some embodiments.

FIG. 3D illustrates an example use case realizing the functionality of the trained example generative AI model, according to some embodiments.

FIG. 4 illustrates an example knowledge generator for implementing the disclosed system, according to some embodiments.

FIG. 5A illustrates an example knowledge mapper for implementing the disclosed system, according to some embodiments.

FIG. 5B illustrates computational models executed based on different AI agents/Models, according to some embodiments.

FIG. 5C illustrates example knowledge units for implementing the disclosed system, according to some embodiments.

FIG. 6A illustrates an example generative optimizer for implementing the disclosed system, according to some embodiments.

FIG. 6B illustrates an example evaluation model for implementing the disclosed system, according to some embodiments.

FIG. 6C illustrates an example use case for generating an optimized visual representation, according to some embodiments.

FIG. 6D illustrates different visual recommendations of an example building structure generated by the system, according to some embodiments.

FIG. 6E illustrates a visual recommendation of an example window panel generated by the system, according to some embodiments.

FIG. 6F illustrates a visual recommendation of an example design of a room generated by the system, according to some embodiments.

FIG. 6G illustrates a first dashboard generated by the system, according to some embodiments.

FIG. 6H illustrates a second dashboard generated by the system, according to some embodiments.

FIG. 7 illustrates a method for generating Virtual Representations of AEC smart constructs, according to some embodiments.

FIG. 8 illustrates a block diagram of an example computer system, according to some embodiments.

FIG. 9 illustrates a block diagram of a basic software system employed for controlling the operation of computing system, according to some embodiments.

### DETAILED DESCRIPTION

The following detailed description is presented to enable a person skilled in the art to make and use the disclosure. For purposes of explanation, specific details are set forth to provide an understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein are able to be applied to other embodiments and applications without departing from the scope of the disclosure. The present disclosure is not intended to be limited to the embodiments shown but is to be accorded the widest possible scope consistent with the principles and features disclosed herein.

In an AEC environment, multiple tasks, processes, and implementations are undertaken to plan any construction related activity. Non-limiting examples are able to include generation and management of diagrammatic and digital representations of a part or whole of construction designs, associated works, and several algorithms-driven planning and management of human, equipment, and material resources associated with undertaking the construction in a real-world environment.

Conventional AEC software solutions provide logistics of the project and represent through a spreadsheet or a diagrammatic representation and enable a user to understand the relationships between buildings, building materials, and other systems in a variety of situations and influence their decision-making processes. However, as described above, such solutions fail to comprehend inputs or dynamic variations and may fail to provide any meaningful insights or action guidance, unable to adapt or make decisions in real-time or near real-time to account for the dynamic nature of a construction project, fail to ascertain prior knowledge of the projects and sufficient understanding of the various aspects to comprehend and interpret the metrics and visual artifacts, and the like.

Conventional techniques provide systems that understand the user intent based on certain data or certain queries provided as an input by the user for the systems. In conventional methodologies, the systems generate responses based on pre-coded possible outcomes for each expected query. That is, the system responses are confined to a finite number of possibilities based on what has worked well or not in the past (for example, based on certain trained data). The conventional systems use user inputs and are able to relate or correlate the intent (of the user) to provide the best outcome within a finite set of outcomes.

Accordingly, there is a need for technical solutions that address the needs described above, as well as other inefficiencies of the state-of-the-art. Thus, there is a need in the art for generating intelligent virtual representations of AEC smart constructs.

To overcome such challenges, the disclosed system goes beyond automating typical human responses by considering a number of possible alternatives including whether a specific task should even be taken up in the first place.

Further, in the present disclosure, the disclosed system further generates content instead of merely spitting out what it has learned, like a thought leader working with the interacting user and creating outcomes. The distinction provided by the disclosed system is that the system generated concepts are being brought to the fore and the interaction is able to go to a different plane than within the scripted confined mode of interaction in the conventional systems.

To achieve its objectives, firstly the disclosed system imbibes knowledge both from the domain specificity, meaning the project-related data warehouse, artifacts, different types of constraints that have worked in the past, and in addition to that, the disclosed system relates to the domain knowledge that exists everywhere else in the world that is made available to it via public sources or otherwise. The disclosed system relates the intrinsic knowledge and knowledge from the outside world together and generates the content by producing artifacts and designing strategies based solely on a finite set of pre-coded outcomes. Such kinds of recommendations that so far were not possible in a machine-learning setting are now possible as the disclosed system starts thinking and articulating such kinds of needs.

Secondly, the time to value is greatly reduced because the user does not have to spend thousands of hours in inputting the logic to the machine to learn and do things but rather now the machine is learning by itself and generating artifacts, code, forms and the like. For example, the disclosed system is able to automatically generate a request for information RFI as to why a pipe rack is blocking the materials staging area with all the data that is pertinent to that incident and will also prepare and describe the task data. Thus, instead of a user having to manually create the RFI form and try to see which task that will be linked to it and what kind of images should be attached to it, the disclosed system is capable of generating this complete form and filling the data relevant information to that particular task. In summary, the disclosed system has the ability to generate domain specific content, the ability to generate formulation of recommendation strategies and the like, on the different facets of AEC impacting all the three paradigms of the industry.

Clearly, the disclosed system is able to improve and execute construction projects more efficiently by addressing the challenges faced with conventional systems, as well as other inefficiencies of the state of the art. Thus, the disclosed system intelligently creates, manages, and executes AEC smart constructs by streamlining and optimizing a design for a construction project based on various forms of knowledge. Such a streamlined and optimized design for the construction project is best suited for a given locale and factoring in set objectives, for example, maximized return on investment (ROI).

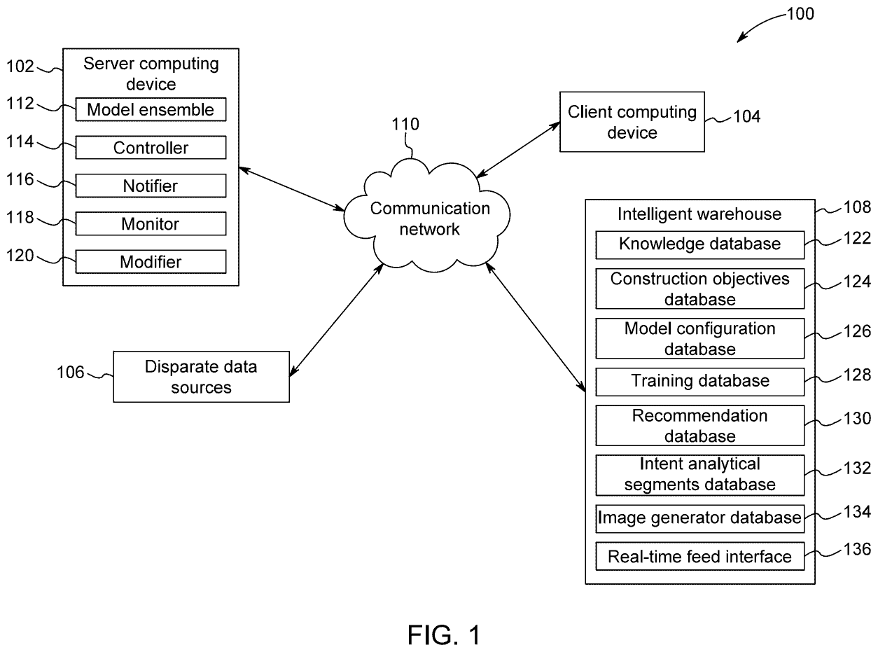

Various embodiments of the methods and systems are described in more detail with reference to FIGS. 1 to 9. Other embodiments, aspects, and features will become apparent from the remainder of the disclosure as a whole.

Certain terms and phrases have been used throughout the present disclosure and will have the following meanings in the context of the ongoing disclosure.

A “network” refers to a series of nodes or network elements that are interconnected via communication paths. In an example, the network is able to include any number of software and/or hardware elements coupled to each other to establish the communication paths and route data/traffic via the established communication paths. In accordance with the embodiments of the present disclosure, the network is able to include, but is not limited to, the Internet, a local area network (LAN), a wide area network (WAN), an Internet of things (IoT) network, and/or a wireless network. Further, in accordance with the embodiments of the present disclosure, the network is able to comprise, but is not limited to, copper transmission cables, optical transmission fibers, wireless transmission, routers, firewalls, switches, gateway computers, and/or edge servers.

A “device” refers to an apparatus using electrical, mechanical, or thermal power and having several parts, each with a definite function and together performing a particular task. In accordance with the embodiments of the present disclosure, a device is able to include, but is not limited to, one or more IoT devices. Further, one or more IoT devices are able to be related to, but are not limited to, connected appliances, smart home security systems, autonomous farming equipment, wearable health monitors, smart factory equipment, wireless inventory trackers, ultra-high speed wireless internet, biometric cybersecurity scanners, and shipping container and logistics tracking. The term “device” in some embodiments, is able to be referred to as equipment or machine without departing from the scope of the ongoing description.

“Virtual reality” (VR) is a computer-generated environment with scenes and objects that appear to be real. This computer-generated environment, presented as a virtually constructed building, or any 3-dimensional (3D) establishment, is perceived through a device, such as a VR headset or helmet.

“Augmented reality” (AR) is an interactive experience of a real-world environment where the objects that reside in the real world are enhanced by computer-generated perceptual information, sometimes across multiple sensory modalities, including visual, auditory, haptic, somatosensory, and olfactory. For example, a real-world picture of a plinth beam of an under-construction building is able to be annotated in a color code different from a cantilever beam owing to different physical characteristics.

A “processor” is able to include a module that performs the methods described in accordance with the embodiments of the present disclosure. The module of the processor is able to be programmed into integrated circuits of the processor, or loaded in memory, storage device, or network, or combinations thereof.

“Machine learning” refers to a study of computer algorithms that are able to improve automatically through experience and by the use of data. Machine learning algorithms build a model based at least on sample data, known as “training data,” in order to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.

In machine learning, a common task is the study and construction of algorithms that are able to learn from and make predictions on data. Such algorithms function by making data-driven predictions or decisions, through building a mathematical model from input data. The input data used to build the model are usually divided into multiple data sets. In particular, three data sets are commonly used in various stages of the creation of the model: training, validation, and test sets. The model is initially fitted on a “training data set” which is a set of examples used to fit the parameters of the model. The model is trained on the training data set using a supervised learning method. The model is run with the training data set and produces a result, which is then compared with a target, for each input vector in the training data set. An example input vector is a feature vector. Based at least on the result of the comparison and the specific learning algorithm being used, the parameters of the model are adjusted. The model fitting is able to include both variable selection and parameter estimation.

Successively, the fitted model is used to predict the responses for the observations in a second data set called the “validation data set.” The validation data set provides an unbiased evaluation of a model fit on the training data set while tuning the model's hyperparameters. Finally, the “test data set” is a data set used to provide an unbiased evaluation of a final model fit on the training data set.

“Database” refers to an organized collection of structured information, or data, typically stored electronically in a computer system.

“Data feed” is a mechanism for users to receive updated data from data sources. The Data feed is commonly used in real-time applications in point-to-point settings as well as on the World Wide Web.

“Ensemble learning” is the process by which multiple models, such as classifiers or experts, are strategically generated and combined to solve a particular computational intelligence problem. Ensemble learning is primarily used to improve the (classification, prediction, function approximation, etc.) performance of a model, or reduce the likelihood of an unfortunate selection of a poor one. In an example, an ML model selected for correlating construction data streams is different from an ML model required for processing a statistical input for sensitivity.

In accordance with the embodiments of the disclosure, a method and system for generating virtual representations of AEC smart constructs is disclosed. The system comprises a controller in a computing device to: determine user intent based on an analysis of a user input; determine one or more project objective constraints based on an evaluation of one or more project objectives; compute knowledge units based on a plurality of nodes and a plurality of interdependencies of a computational graph, wherein the plurality of nodes corresponds to one or more of the user intent and the one or more project objectives, and wherein the plurality of interdependencies is established between the plurality of nodes based on the one or more project objective constraints; perform one or more computational simulations for the user intent based on the knowledge units; and generate one or more virtual representations of the AEC smart constructs in a digital environment based on the one or more computational simulations, wherein the one or more computational simulations meet a defined criteria associated with the one or more project objectives.

FIG. 1 illustrates an example network computing system 100 in which various embodiments of the present disclosure are able to be implemented. FIG. 1 is shown in simplified, schematic format for purposes of illustrating a clear example and other embodiments are able to include more, fewer, or different elements. FIG. 1 and the other drawing figures, and all of the description and claims in this disclosure are intended to present, disclose, and claim a technical system and technical methods. The technical system and methods as disclosed include specially programmed computers, using a special-purpose distributed computer system design and instructions that are programmed to execute the functions that are described. These elements execute to provide a practical application of computing technology to the problem intelligent creation, management, and execution of AEC smart constructs by streamlining and optimizing a design for a construction project based on various forms of knowledge. In this manner, the current disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In some embodiments, the example network computing system 100 is able to include a server computing device 102, a client computing device 104, disparate data sources 106, and an intelligent warehouse 108, which are communicatively coupled directly or indirectly via a communication network 110. The elements in FIG. 1 are intended to represent one workable embodiment but are not intended to constrain or limit the number of elements that could be used in other embodiments.

The server computing device 102 is able to include one or more computer programs or sequences of program instructions in an organization. Such organization implements machine intelligence, smart knowledge assembly, AI, ML, and cognitive systems and methods to generate virtual representation of smart AEC constructs based on data received from disparate sources. In some embodiments, AEC constructs are able to refer to one or more portions of a construction project, such as a window panel, a living room, or a building as a whole, decided based on the user intent.

Programs or sequences of instructions organized to implement the controlling functions are able to be referred to herein as a controller 114. Programs or sequences of instructions organized to implement the notifying functions are able to be referred to herein as a notifier 116. Programs or sequences of instructions organized to implement the monitoring functions are able to be referred to herein as an efficiency analysis and process monitor 118 (referred to as “monitor 118” herein). Programs or sequences of instructions organized to implement the modifying functions are able to be referred to herein as a modifier 120. The controller 114, the notifier 116, the monitor 118, and the modifier 120 are able to be integrated together as a system on chip or as separate processors/controllers/registers. Accordingly, the respective functions of the controller 114, the notifier 116, the monitor 118, and the modifier 120 essentially correspond to processing or controller functions.

The model ensemble 112, the controller 114, the notifier 116, the monitor 118, and/or the modifier 120 are able to be part of an AI system implemented by the server computing device 102. In some embodiments, the network computing system 100 is able to be an AI system and include the client computing device 104, the server computing device 102, and the intelligent warehouse 108 that are communicatively coupled to each other. An example AI-based system is described in U.S. Pat. No. 11,531,943, issued Dec. 20, 2022, and titled “Artificial Intelligence Driven Method and System for Multi-factor Optimization of Schedules and Resource Recommendations for Smart Construction,” the entire contents of which are hereby incorporated by reference for all purposes as if fully set forth herein. In some embodiments, one or more components of the server computing device 102 are able to include a processor configured to execute instructions stored in a non-transitory computer readable medium.

In some embodiments, the model ensemble 112 is able to include a plurality of modules, and each of the plurality of modules is able to include an ensemble of one or more AI models (e.g., Language Model, Transformer Model, Multilayer Perceptron, Lucas-Kanade, Adaptive Image Thresholding, Graph Cut Optimization, Support Vector Machines, Bayesian learning, K-Nearest Neighbor, Decision Graph) to process a corresponding data feed. The data feed in turn corresponds to current data received in real-time from data sources such as a local or remote database as corresponding to the knowledge database 122. Each module, which is a combination of plurality of ML modules, is programmed to receive a corresponding data feed from the knowledge database 122. Based on pertinent segments or attributes of the data feed mapping with a function objective(s), a respective module determines or shortlists an intermediary data set. For example, the intermediary data set is able to include, but is not limited to, a semantic interpretation of accrued and incoming data, a dynamic data ontology, weighted relationship amongst data segments, formulation of knowledge graph intermediate vertices and edges and that includes influencing factors in a construction project. Further, the data feed is defined by a data structure comprising a header that includes metadata or tags at an initial section or a header of the data feed, such that the metadata or tags identify segments and corresponding data types. Alternatively, in absence of header, the metadata or tags are able to be mixed with payload in the data feed. For example, each data segment of the data feed is able to include metadata indicating a data type that the data segment pertains to. If the data type corresponds with the function objective of the respective module, then the respective module will process that data segment. The intermediary data sets are then able to be used by the controller 114 to execute one or more actions based on user inputs and/or objectives.

In some embodiments, the model ensemble 112 is able to include multiple models, such as classifiers or experts, strategically generated and combined to solve a particular computational intelligence problem. Ensemble learning is primarily used to improve the (classification, prediction, function approximation, and the like) performance of a model, or reduce the likelihood of an unfortunate selection of a poor one. In an example, an ML model selected for gathering a user intent from an input is different from an ML model required for processing a statistical input for sensitivity. The model ensemble 112 is able to include machine learning techniques, deep learning techniques, neural networks, deep learning with hidden layers, or a combination of these techniques.

In some embodiments, the notifier 116 is able to be programmed to provide notifications to the user. The notifier 116 is able to receive such notifications from the controller 114 and the intelligent warehouse 108. The notifications are able to include, but are not limited to, audio, visual, or textual notifications in the form of indications or prompts. The notifications are able to be indicated in a user interface (e.g., a graphical user interface) to the user. In one example, the notifications are able to include, but not limited to, recommendations and/or alerts associated with fitting within the bounds of project objective and evaluated for maximized returns within that set objective. In other example, a notification is able to include graphical representation of designs of a construction project. In other example, a notification allows an avatar or personified animation of the user to navigate the virtual environment for visual introspection through a virtual reality headgear worn over the head and/or a stylus pen held in hand as known in the state of the art. Based on a head or limb movement of the user wearing the virtual reality headgear, the avatar is able to walk-through or drive-through various virtual locations of the metaverse. In other example, a notification facilitates such avatar to make real-time changes/updates/annotations that affect the investment objective and/or project.

In some embodiments, the monitor 118 is programmed to receive feedback that is able to be used to execute corrections and alterations at the controller 114 side to fine tune decision making. For example, the monitor 118 is able to be programmed to receive data feeds from one or more external sources, such as the disparate data sources 106.

In some embodiments, the modifier 120 is able to be programmed to receive modification data to update existing artificial intelligence models in the network computing system 100 and to add new artificial intelligence models to the network computing system 100. Modification data is able to be provided as input by the user via an input interface (e.g., a graphical user interface). In other example, the modification is able to be determined automatically through external sources and/or databases.

In some embodiments, in keeping with sound software engineering principles of modularity and separation of function, the model ensemble 112, the controller 114, the notifier 116, the monitor 118, and the modifier 120 are each implemented as a logically separate program, process, or library. The model ensemble 112, the controller 114, the notifier 116, the monitor 118, and the modifier 120 are also able to be implemented as hardware modules or a combination of both hardware and software modules without limitation.

Computer executable instructions described herein are able to be in machine executable code in the instruction set of a Central Processing Unit (CPU) and are able to be compiled based upon source code written in Python, JAVA, C, C++, OBJECTIVE-C, or any other human-readable programming language or environment, alone or in combination with scripts in JAVASCRIPT, other scripting languages, and other programming source text. In some embodiments, the programmed instructions are also able to represent one or more files or projects of source code that are digitally stored in a mass storage device such as non-volatile Random Access Memory (RAM) or disk storage, in the system of FIG. 1 or a separate repository system, which when compiled or interpreted cause generation of executable instructions that in turn upon execution cause the computer to perform the functions or operations that are described herein with reference to those instructions. In other words, the figure represents the manner in which programmers or software developers organize and arrange source code for later compilation into an executable, or interpretation into bytecode or the equivalent, for execution by the server computing device 102.

In some embodiments, the server computing device 102 broadly represents one or more computers, such as one or more desktop computers, server computers, a server farm, a cloud computing platform, a parallel computer, virtual computing instances in public or private datacenters, and/or instances of a server-based application. The server computing device 102 is able to be accessible over the communication network 110 by the client computing device 104, for example, to receive one or more user inputs.

In some embodiments, the server computing device 102 broadly represents one or more computers, such as one or more desktop computers, a server farm, a cloud computing platform (like Amazon EC2, Google Cloud, container orchestration (Kubernetes, Docker, and the like), or a parallel computer, virtual computing instances in public or private datacenters, and/or instances of a server-based application. The server computing device 102 is able to be coupled to various other resources, such as the disparate data sources 106 and intelligent warehouse 108 via the communication network 110.

The disparate data sources 106 are able to correspond to a plurality of different resources that are disparate and seemingly unrelated to one another. Data/knowledge sourced from such disparate data sources 106 is both domain specific as well as correlational knowledge. Such sourced data/knowledge is able to correspond to different types or formats residing in separate systems, databases, or file formats, and that are not necessarily designed to be integrated or compatible with each other. In some embodiments, the controller 114 in the server computing device 102 is able to conduct a combinatorial analysis of the data/knowledge provided by such disparate data sources 106 by applying a plurality of ensembles of machine learning models to each of the plurality of data sources, for example identify relationships between various data streams and then channelize the learnings to form correlation and/or linkages between data. The controller 114 is able to build relationships within the data sets and/or data streams that may appear unrelated, and utilize computational, mathematical, and statistical models and machine learning algorithms to correlate the seemingly unrelated data.

The client computing device 104 is able to include a desktop computer, laptop computer, tablet computer, smartphone, or any other type of computing device that allows access to the server computing device 102.

The intelligent warehouse 108 is able to include additional databases storing data that is able to be used by the server computing device 102. Each database is able to be implemented using memory, e.g., RAM, EEPROM, flash memory, hard disk drives, optical disc drives, solid state memory, or any type of memory suitable for database storage. The intelligent warehouse 108 is able to include various databases, such as a knowledge database 122, a project objectives database 124, a model configuration database 126, a training database 128, a recommendation database 130, an intent analytical segments database 132, an image generator database 134, and a real-time feed interface 136.

In some embodiments, the knowledge database 122 is able to store a plurality of data feeds collected from various disparate data sources, such as a construction site or an AEC site, third-party paid or commercial databases, and real-time feeds, such as Really Simple Syndication (RSS), or the like. A data feed is able to include data segments pertaining to real-time climate and forecasted weather data, structural analysis data, in-progress and post-construction data, such as modular analysis of quality data, inventory utilization and forecast data, regulatory data, global event impact data, supply chain analysis data, equipment and IoT metric analysis data, labor/efficiency data, and/or other data that are provided to the modules of the modules of the model ensemble 112 in line with respective project objective(s). A data feed is able to include tenant data relating to either other ancillary construction projects or activities of such ancillary construction projects, or both. Each data segment is able to include metadata indicating a data type of that data segment. As described herein, the real-time data, near real-time data, and collated data are received by the monitor 118 and are processed by various components of the server computing device 102 based on the user intent and project objectives.

In some embodiments, the project objectives database 124 is able to include a plurality of project objectives. Each of the plurality of data feeds in the knowledge database 122 is processed to achieve one or more project objectives of the plurality of project objectives in the project objectives database 124. The project objectives, as exemplified in the forthcoming description, are a collection of different user requirements, project requirements, regulatory requirements, technical requirements, and the like, related to a construction project. The project objectives are able to be established prior to the start of construction activities and are able to be adjusted during construction phases to factor in varying conditions. The project objectives are defined at each construction project and construction phase level. Data definition of project objectives defines normalized project objectives. Examples of such normalized objectives include parameters for optimization of construction schedule to meet time objectives, optimization for cost objectives, optimization for carbon footprint objectives, which are normalized to factor in worker health, minimization of onsite workers, and minimization of quality issues. One or more project objectives are able to be identified as part of a user input for a construction activity of a construction project. Further, the project objectives are able to be determined from the user input and/or user intent based on a natural language parser and a work tokenizer.

In one example, a project objective is able to be to keep the cost below a budgeted amount. The monitor 118 is able to receive data feeds corresponding to cost analysis from external sources and store the data feeds in knowledge database 122. The controller 114 is able to receive the data feeds from the knowledge database 122, or alternatively, receive the data feeds from the monitor 118, and then check the received data feeds against the established or objectives (e.g., a set benchmark or threshold) to be in alignment for set project objectives stored in the project objectives repository. While the set benchmark corresponds to a predefined metric, the set objective corresponds to an objective created in real time based on the user input and specifically the user intent. For example, if the incoming data feeds indicate that construction completion date may exceed a deadline, then the controller 114 is able to explore one or more solutions to expedite. In this context, the controller 114 is able to determine that reshuffling of tasks, adding additional construction workers, and procuring materials from a nearby supplier even at the cost of higher expenditure than proposed budget is expected to minimize shipping time and eventually help in meeting the proposed deadline associated with the completion date. However, since the desired objective is also to keep the cost below or at the allotted budget level, system recommendation from the controller 114 might also resort to overlook expediency and instead maintain work at the current pace with the current mandates. Such system recommendation to ignore expediency and persist with the current pace and resources is expected to have checked the project objectives database 124 as well as any other legal commitments, before giving up the options to expedite and persist with current pace. In a different example scenario, if the project objective is to honor the set construction completion date at the cost of preset budget, then the system recommendation is able to override the current pace of work and instead enforce its explored recommendations to expedite, e.g., adding additional construction workers, procuring material from a nearby supplier among other considerations.

In some embodiments, the model configuration database 126 is able to include configuration data, such as parameters, gradients, weights, biases, and/or other properties, that are required to run the artificial intelligence models after the artificial intelligence models are trained. The configuration data is able to be continuously updated.

In some embodiments, the training database 128 is able to include training data for training one or more artificial intelligence models of the network computing system 100. The training database 128 is continuously updated with additional training data obtained within the network computing system 100 and/or external sources. Training data includes historical data, factual data, and human cognitive factors associated with a user and AEC smart constructs. Human cognitive factors indicate how does a human expert devoid of emotional variables decide and act in certain situations, such as, interpreting a given situation, a given constraint, a given element or in dealing with a sub-optimal situation leading to a schedule or cost impediment. For example, in a given situation along the course of a construction project, how would a site supervisor decide if a given set of tasks run into effort overruns.

Training data further includes algorithm-generated synthetic data tailored to test efficiencies of different artificial intelligence models described herein. Synthetic data is able to be authored to test a number of system efficiency coefficients. The system efficiency coefficients are able to include false positive and negative recommendation rates, model resiliency, and model recommendation accuracy metrics.

In some embodiments, the recommendation database 130 includes recommendation data, such as recommended actions associated with the construction project. For example, the server computing device 102 is able to generate recommendation data that offers designs of a construction project for different scenarios. In another example, the server computing device 102 is able to generate recommendation data not to proceed with the construction project since based on its computations that indicate that the return on investments would be non-existent or counter-productive.

The intent analytical segments database 132 is able to parse, identify, store, and analyze analytical portions of user inputs related to an intent of a user. The image generator database 134 is able to convert non-graphic data feeds to graphic and/or images for further analysis and/or depiction. Further, the feed interface 136 is able to provide real-time data, such as, a live camera feed, to the intelligent warehouse 108.

The communication network 110 broadly represents a combination of one or more LANs, WANs, metropolitan area networks (MANs), global interconnected internetworks, such as the public internet, or a combination thereof. Each such network is able to use or execute stored programs that implement internetworking protocols according to standards such as the Open Systems Interconnect (OSI) multi-layer networking model, including but not limited to, Transmission Control Protocol (TCP) or User Datagram Protocol (UDP), Internet Protocol (IP), Hypertext Transfer Protocol (HTTP), and so forth. All computers described herein are able to be configured to connect to the communication network 110 and the disclosure presumes that all elements of FIG. 1 are communicatively coupled via the communication network 110. The various elements depicted in FIG. 1 are also able to communicate with each other via direct communication links that are not depicted in FIG. 1 to simplify the explanation.

The ML models disclosed herein are able to include appropriate classifiers and ML methodologies. Some of the ML algorithms include (1) Multilayer Perceptron, Support Vector Machines, Bayesian learning, K-Nearest Neighbor, or Naive Bayes as part of supervised learning, (2) Generative Adversarial Networks as part of Semi Supervised learning, (3) Unsupervised learning utilizing Autoencoders, Gaussian Mixture and K-means clustering, and (4) Reinforcement learning (e.g., using a 0-learning algorithm, using temporal difference learning), and other suitable learning styles. Knowledge transfer is applied, and, for small footprint devices, Binarization and Quantization of models is performed for resource optimization for ML models. Each module of the plurality of AI models is able to implement one or more of: a Language Model, regression algorithm (e.g., ordinary least squares, logistic regression, stepwise regression, multivariate adaptive regression splines, locally estimated scatterplot smoothing, and the like), an instance-based method (e.g., k-nearest neighbor, learning vector quantization, self-organizing map, and the like), a regularization method (e.g., ridge regression, least absolute shrinkage and selection operator, elastic net, and the like), a decision tree learning method (e.g., classification and regression tree, iterative dichotomiser 3, C4.5, chi-squared automatic interaction detection, multivariate adaptive regression splines, gradient boosting machines, and the like), a Bayesian method (e.g., naïve Bayes, averaged one-dependence estimators, Bayesian belief network, and the like), a kernel method (e.g., a support vector machine, a radial basis function, a linear discriminate analysis, and the like), a clustering method (e.g., k-means clustering, expectation maximization, and the like), an associated rule learning algorithm (e.g., an Eclat algorithm, and the like), an artificial neural network model (e.g., a Perceptron method, a back-propagation method, a self-organizing map method, a learning vector quantization method, and the like), a deep learning algorithm (e.g., a restricted Boltzmann machine, a deep belief network method, a convolution network method, a stacked auto-encoder method, and the like), and a dimensionality reduction method (e.g., principal component analysis, partial least squares regression, multidimensional scaling, and the like). Each processing portion of the network computing system 100 is additionally able to leverage: a probabilistic, heuristic, deterministic or other suitable methodologies for computational guidance, recommendations, machine learning or combination thereof. However, any suitable machine learning approach is able to otherwise be incorporated in the network computing system 100. Further, any suitable model (e.g., machine learning, non-machine learning, and the like) is able to be used in the network computing system 100 of the present disclosure.

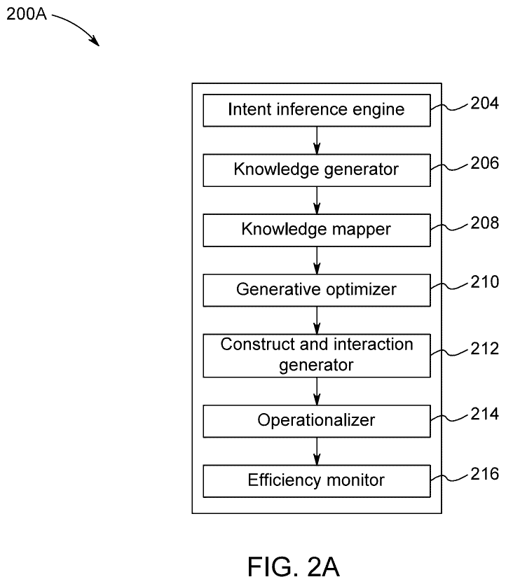

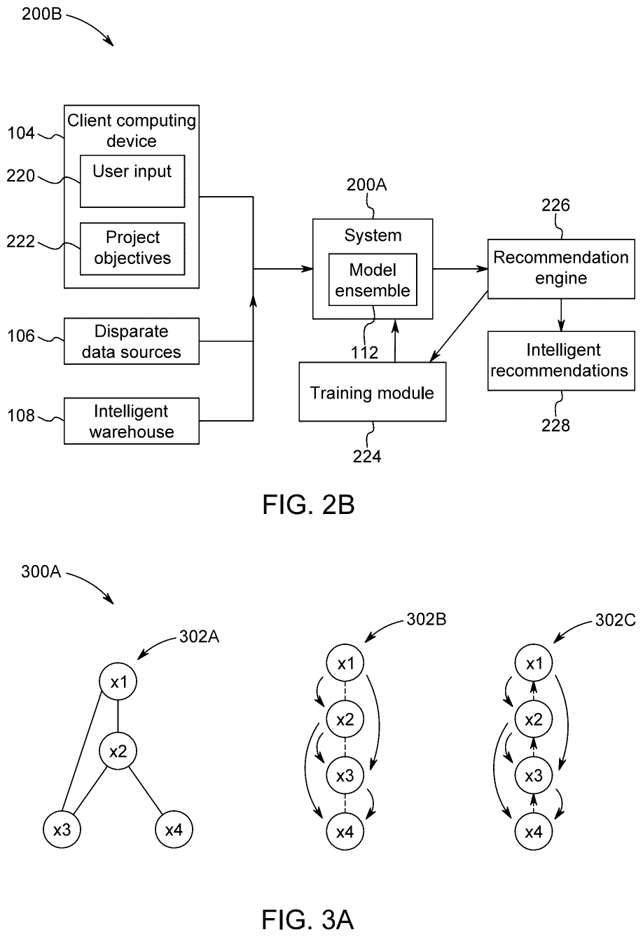

FIG. 2A illustrates an example system 200A for generating virtual representation of AEC smart constructs, according to some embodiments. The system 200A is able to be configured to ingest, assimilate, infer, and synthesize knowledge (such as, temporal, spatial, and analytical knowledge) from events (such as, real world events), entities, and processes to intelligently create, manage, and execute AEC smart constructs, according to some embodiments. In some embodiments, the system 200A is able to be implemented on the server computing device 102 that is accessible by one or more client computers, such as the client computing device 104, via a network, such as the communication network 110. Further, in some embodiments, the disclosed system 200A is able to be configured to create or generate additional knowledge based on other learnt knowledge (in an example, knowledge other than the temporal, spatial, and analytical knowledge) with focus on AEC processes and implementations.

In some embodiments, the system 200A includes various modules including, but not limited to, an Intent Inference Engine 204, a Knowledge Generator 206, a Knowledge Mapper 208, a Generative Optimizer 210, a Construct and Interaction Generator 212, an Operationalizer 214, and an Efficiency Monitor 216. One or more of the above modules are able to be implemented using software, hardware, firmware, or a combination thereof. In some embodiments, one or more modules are able to implement and use machine intelligence, smart knowledge assembly, AI, ML, and cognitive methods for implementation of their associated functionalities. In some embodiments, the system 200A is able to correspond to computing device(s) that are able to be hard-wired to perform the techniques or are able to include digital electronic devices, such as at least one application-specific integrated circuit (ASIC) or field programmable gate array (FPGA), that is persistently programmed to perform the techniques or is able to include at least one general purpose hardware processor programmed to perform the techniques pursuant to program instructions in firmware, memory, other storage, the one or more modules, or a combination. Such computing device(s) are also able to combine custom hard-wired logic, ASICs, or FPGAs with custom programming to accomplish the described techniques.

In some embodiments, the Intent Inference Engine 204 is able to receive a user input 220, such as from the client computing device 104, and generate intent inferences from the received user input 220. In some embodiments, intent inferences are generated from the received user input 220 using one or more machine intelligence, smart knowledge assembly, AI, ML, and/or cognitive methodologies. In some embodiments, intent inferences are achieved through application of one or more logical rules to the user input 220 to evaluate and analyze new information. For example, a logical rule that is inferred and machine composed is able to be—If the phase of a construction project is an initial preconstruction phase and the user is asking the system 200A a question—“Update me on the Project”, the system 200A understands the user intent as a general update on permits, land preparation and allotted budget. However, if during the construction phase, if the construction project is facing delays and overruns, and the user asks the same question to the system 200A, at this time, the system 200A understands the criticality of the situation, and the intent is to find solutions to unblock the impediments. Based on the notion, the system 200A is able to state the impediments and resolutions and not go into a verbose articulation of the project updates. This is able to be referred to as situational intelligence. The logical rules composed in such an example case are able to be—Factor in phase, criticality, schedule, and cost impact at a given time and use that to compose appropriate knowledge units to respond to a user input.

Such a process is able to involve two phases. The first phase corresponds to a training phase where intelligence is able to be developed by recording, storing, and labeling information. If, for example, a machine is being trained to identify construction material used to plaster interior walls of a construction project (in an example, for a building), an ML algorithm is fed with various data related to construction material, the machine is able to later refer to. The uniqueness of the training approach is to factor in human cognitive factor(s) besides factual and historical data. The human cognitive factor(s) are able to indicate how a human expert, devoid of emotional variables, decides and acts in certain situations, for example, interpreting a given situation, a given constraint, a given element, or in dealing with a sub-optimal situation leading to a schedule or cost impediment. In a given situation along the course of a construction project, the human cognitive factor(s) are able to indicate how would a site supervisor decide if a given set of tasks run into effort overruns. Such human cognitive factors, as part of the AI Machine training, is unique and different from the conventional model training methodologies.

Second, is the inference phase where the machine uses the intelligence gathered through the application of the one or more logical rules to the user input 220, to understand new data. In this phase, the machine is able to use inference to identify and categorize construction material as “construction material used to plaster interior walls of a building” despite having never analyzed or seen it before. As the design or the task gets resource loaded with supplies, the system 200A is able to perform correlational analysis to understand what material is used and for what purpose. As the system 200A introspects the usage from prior data, the triangulation of information as to space, geometry, and time along analysis of past human actions is able to enable the system 200A to compose its knowledge unit as to how to interpret a given situation and user intent and is able to offer appropriate recommendations. In more complex scenarios, such inference learning is able to be used to augment human decision making. Thus, in an example, when the user intent is to “plaster interior walls of a building”, the Intent Inference Engine 204 is able to generate intent inferences that recommend one or more types of construction material used to plaster interior walls in a construction project. In some embodiments, the user intent is able to be derived from the user input. As an example, the user input is able to include a query, an instruction, and/or an electronic file related to a construction project associated with the AEC smart constructs. For an instance, one user input is able to be a query regarding the creation of construction project, or on a projected timeline of the completion of a construction project. Further, the query is able to be directed to details on materials and designs to be used for the construction project, the location of the construction project, and/or ways on how to expedite the completion of the construction project given certain parameters and/or conditions. In some embodiments, the user input is able to include an instruction to create a virtual representation of a construction project (based on a construction blueprint provided by the user). The blueprint is able to include artifacts such as, but not limited to, a computer aided design (CAD) documentation, a 2D floor plan, and/or a 3D architecture layout to construct a 3D digital/virtual representation (e.g., metaverse) of the construction project based on a building information model (BIM). In some embodiments, the user input is able to include an instruction to create the virtual representation of the construction project based on an intent of the user, without any specific artefact provided by the user. For instance, the user is able to provide a verbal input as “create a 5-story building with minimal environmental impact” and “present the virtual representation of the created building,” or “show cost-effective ways to install wooden beams on the roof of first floor.” Accordingly, the user input is parsed, for example, through a Natural language processing (NLP) parser to determine keywords and thereby determine an intent of the provided user input.

Example methods of determining intent are described in U.S. Provisional Patent Application having Ser. No. 63/324,715, filed Mar. 29, 2022, and titled “System and methods for intent-based factorization and computational simulation,” U.S. patent application Ser. No. 17/894,418, filed Aug. 24, 2022, and titled “System and Method for Computational Simulation and Augmented/Virtual Reality in a Construction Environment,” International Application No. PCT/US2023/016515, filed Mar. 28, 2023, and titled “System and Method for Inferring User Intent to Formulate an Optimal Solution in Construction Environment,” and International Application No. PCT/US2023/016521, filed Mar. 28, 2023, and titled “System and Method for Intent-Based Computational Simulation in a Construction Environment,” the entire contents of which are hereby incorporated by reference for all purposes as if fully set forth herein. Once the intent is determined, the intent inferences are generated by the Intent Inference Engine 204 as discussed in the description of FIG. 2A below.

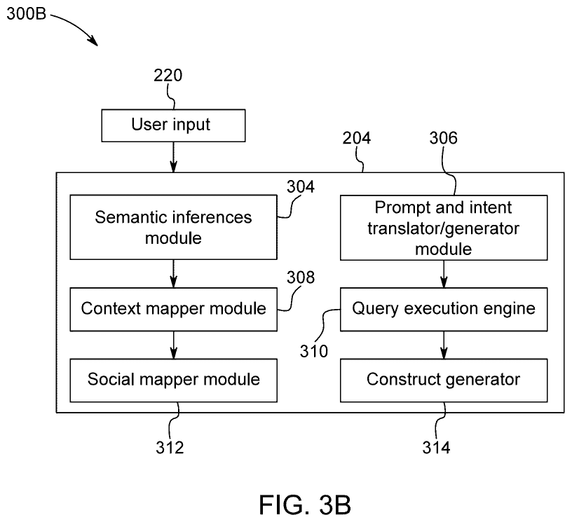

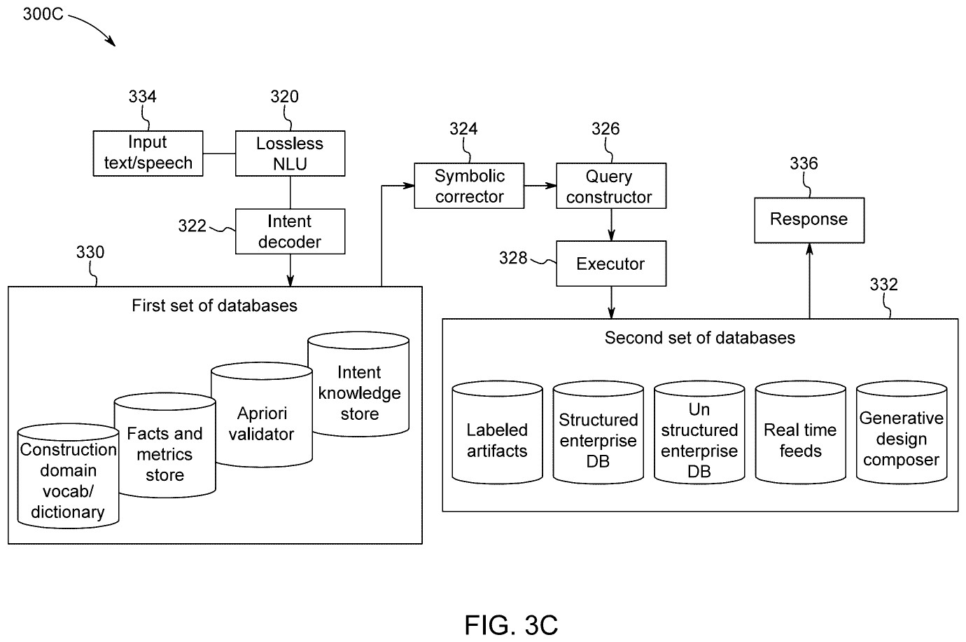

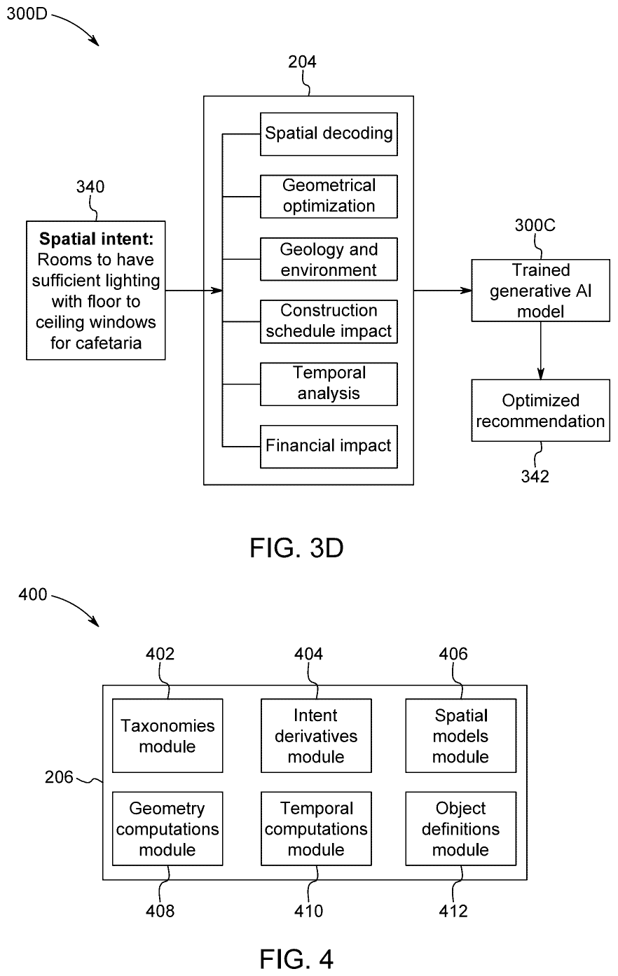

In some embodiments, the Intent Inference Engine 204 is able to be configured to process ecosystem data in an AEC environment related to a construction project. For example, the Intent Inference Engine 204 is able to parse the design and design composites to infer the intent of a user, such as, an Architect. The Intent Inference Engine 204 is able to interpret the schedule intent and expectations with respect to time and cost. The Intent Inference Engine 204 is able to further use the same as a prevailing construct. The Intent Inference Engine 204 is able to further infer the design nuances and the intent due to the relationship with space and geometry parameters. The Intent Inference Engine 204 is able to analyse the intent and translate the intent into a machine understandable criterion, as illustrated in various computational graphs 300A in FIG. 3A.

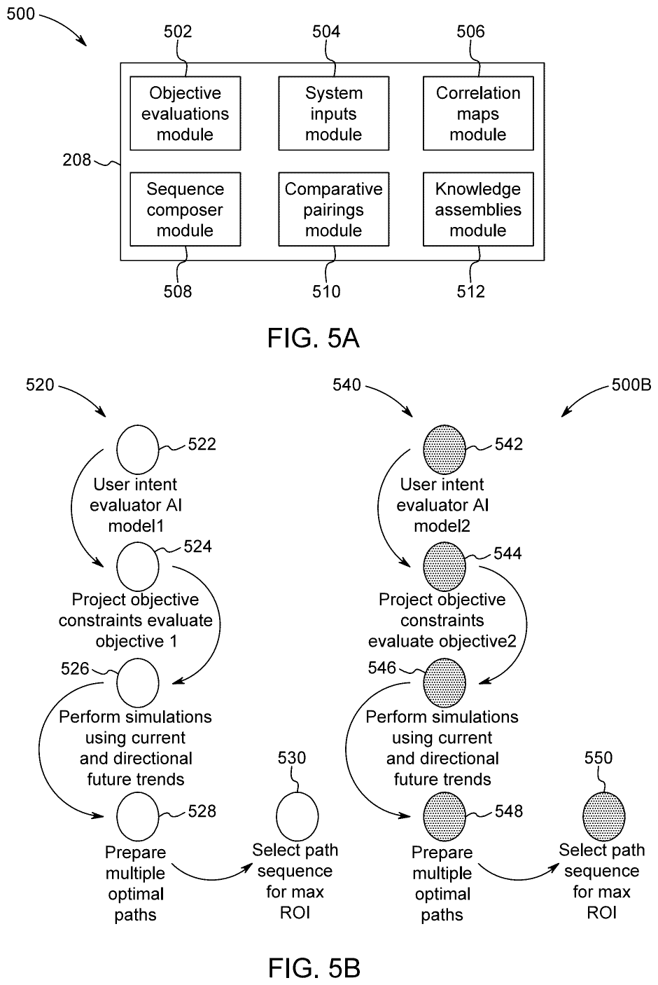

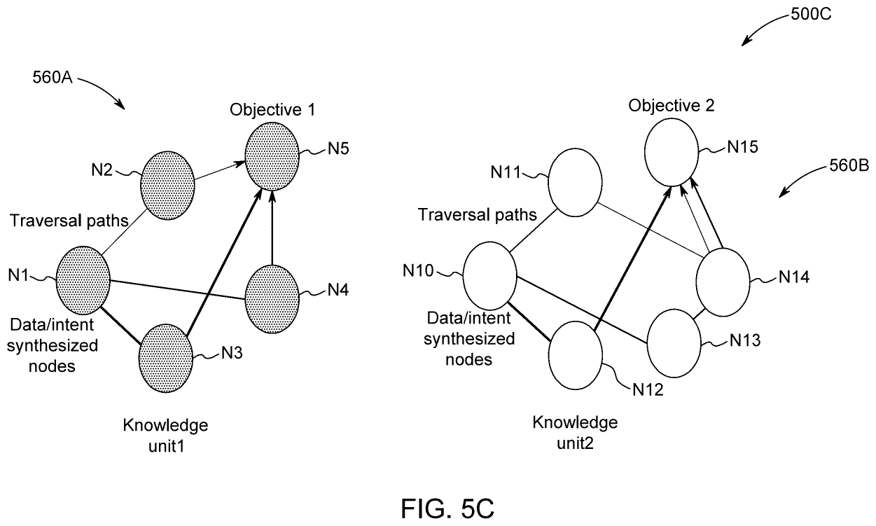

Referring to FIG. 3A illustrating the computational graphs 300A, there are shown a first graph 302A, a second graph 302B, and a third graph 302C. All of the three computational graphs 302A, 302B, and 302C are shown to include a plurality of nodes, such as Nodes x1 . . . x4. Each of the Nodes x1 . . . x4 are able to correspond to an intent variable determined from analyzing multiple user intents. Referring to the first graph 302A, the relationships amongst the user intents are run through a computational simulation to understand their dependencies and influences on each other based on which the plurality of nodes, such as Nodes x1 . . . x4, are linked to one another. The second graph 302B includes source and knowledge units as the plurality of nodes, such as Nodes x1 . . . x4, indicating a first traversal path to understand the intent of the user. The intent is correlated with the project objective to compute a plurality of parameters. A supervisory algorithm is able to validate the second graph 302B if the generated prediction is optimal. Thus, the second graph 302B provides a foundational knowledge that the system 200A builds up. The Third Graph 302C corresponds to a supervisory algorithm that provides appropriate recommendations generated by the Nodes x1 . . . x4. Thus, the first traversal path indicated in the second graph 302B and the second traversal path indicated in the third graph 302C are evaluated for directionality. Once an optimal inference is achieved on the user intent and its implications, then the system 200A sources the same as a knowledge unit which is transmitted to downstream modules, such as the Knowledge Generator 206. The knowledge unit is further described in detail in FIG. 5B. The Knowledge Generator 206 is able to store the user intent and dependencies as composite polyglot entities (multiple persistent stores) including vectors, graphs, and dimensional entities.

Referring to FIG. 3B, an example Intent Inference Engine 204 is illustrated according to some embodiments for predicting or determining user intent inference for a user intent/input, such as user input 220. In some embodiments, the Intent Inference Engine 204 is able to include various modules, such as, a Semantic Inference Module 304, a Prompt and Intent Translator/Generator Module 306, a Context Mapper Module 308, a Query Execution Engine 310, a Social Mapper Module 312, and a Construct Generator Module 314.

In some embodiments, upon receiving the user input 220, the Semantic Inference Module 304 is able to be configured to generate intent inferences based on the semantics of the user input 220. In some embodiments, the Semantic Inference Module 304 is able to perform a computational process to understand various language phrases, AEC domain specific vocabulary, localized lingo to a region, and the like. Such language phrases, AEC domain specific vocabulary, and localized lingo is able to be then validated against an internal knowledge dictionary and verified to check if it has a meaningful impact on the outcomes. If the data is valid and if some of the data and word composites are new, the Semantic Inference Module 304 is able to then add the same to a dataset. Some of such inferences are from earlier questions in a question flow to understand the intent of user. Such insights are determined in the form of new relationships, providing connections in the data that were previously unobserved.

In some embodiments, the Prompt and Intent Translator/Generator Module 306 is able to be configured to generate and/or analyze prompts identified based on the user input 220. Thus, the Prompt and Intent Translator/Generator Module 306 is able to be configured to translate some or all portions of the user input 220, as required for further analysis.

In some embodiments, the Context Mapper Module 308 is able to be configured to map the processed user input 220 with a context relevant to the construction project, a current scenario, or the user input 220.

In some embodiments, the Query Execution Engine 310 is able to be configured to execute one or more user queries. The one or more user queries are able to include phrases and semantic cues (for example, “fastener tie wall”). The phrases and semantic cues in the one or more user queries are able to be construed based on a construction stage, phase and current work done to indicate the user interest in locating a wall fastener and additional notes on its installation. The one or more user queries are able to be executed using one or more machine intelligence, smart knowledge assembly, AI, ML, and cognitive techniques to derive one or more user intents.

In some embodiments, the Social Mapper Module 312 module is able to be configured to map the user intent with corresponding social scenario and/or a social cause associated with a construction project. In some embodiments, the social cause is able to be to reduce pollution whereas in some other embodiments, the social cause is able to be to include design and planning to ease traffic congestion or minimize congestion during and post construction, noise and vibration metrics for neighborhood, landscape, and visual aesthetics to blend in with the surroundings and social expectations.

In some embodiments, the Construct Generator Module 314 is able to be configured to provide abilities that allow the creation of constructs or objects. In some embodiments, the constructs or objects are created based at least on the generated one or more intent inferences.

Referring to an example Generative AI model 300C in FIG. 3C realizing the functionality of the Intent Inference Engine 204, there are shown various components, such as a lossless NLU 320, an intent decoder 322, a symbolic corrector 324, a query constructor 326, and an executor 328. Further, there are shown a first set of databases 330 and a second set of databases 332.

Upon receiving an input text/speech 334 as a user input, the lossless NLU 320 is able to be configured to generate a structured output that represents a symbolic representation of the unstructured input text/speech 334. The intent decoder 322, based on the structured output, is able to generate candidate intent results corresponding to a general intent of the user. Based on the correlation of the general intent of the user and the first set of databases 330, such as construction domain vocab/dictionary, facts and metrics store, apriori validator, and intent knowledge store, the symbolic corrector 324 is able to be configured to score the candidate intent results based on various factors, such as likelihood of the speech recognition result, scores of the candidate intent results, and the standby weight, determined by the other modules of the example Generative AI Model 300B. Based on the results generated by the symbolic corrector 324 that correspond to established user intent, the query constructor 326 is able to be configured to generate query constructs. The executor 328 is able to be configured to execute the query constructs generated by the query constructor 326. Based on the correlation of the executed query constructs and the second set of databases 332, such as labelled artifacts, structured enterprise database, unstructured enterprise database, real time feeds, and Generative design composer, an intent response 336 is able to be generated during a training phase of the example Generative AI Model 300B.

In some embodiments, the Generative AI model 300C is able to be trained using the model ensemble 112 that is able to run multiple scenarios varying one or more data attributes and/or model features to generate and/or adjust recommendations. The model ensemble 112 is able to decide weights to assign to various parameters for scenario modelling and/or correlation analysis to generate weighted outputs. The model ensemble 112 is able to vary assigned weights to minimize the difference between the predictions and the actual data or expected data. The model ensemble 112 is able to calculate the gradient of loss function with respect to each weight by using several computational techniques, such as, but not limited to, the chain rule. Thus, the model ensemble 112 adjusts the weights to decrease the loss, that is, if a weight's adjustment leads to a decrease in loss, the gradient will be negative, indicating the weight should be increased, and vice versa. Lastly, the model is able to update its weights using the gradients calculated during backpropagation. This is able to be done with an optimization algorithm, such as, but not limited to, Gradient Descent, and the like. These steps are able to be repeated for many iterations over an entire dataset, gradually improving the model's weights and, consequently, its predicted recommendations. Throughout this iterative process, the model “learns” by adjusting its weights to minimize the loss, thereby improving its accuracy in making predictions based on the input data it receives. During the training process, the model ensemble 112 is able to leverage various model features as the input data. Apart from the historic data retrieved from the intelligent warehouse 108, the model features are also able to include cognitive inputs from the user that correspond to the behavioral pattern of the user in response to interactional dialogues generated by the system 200A. For example, in a given situation along the course of a construction project, how would a site supervisor decide if a given set of tasks run into effort overruns.

Referring to an example Use Case 300D in FIG. 3D realizing the functionality of the trained example Generative AI model 300C, there is shown a user query 340, for example, “Rooms to have sufficient lighting with floor to ceiling windows for cafeteria.” indicating a spatial intent. The Intent Inference Engine 204 is able to determine various intent variables corresponding to the user query 340. Examples of the intent variables are able to include, but are not limited to, spatial decoding (such as design and orientation of a given space), geometrical optimization (such as computed optimal dimensions of the given artifact), geology and environment (such as given locale), construction schedule impact (such as work packs, work orders, sequence and timing of materials needed), temporal analysis (such as, financial impact (such as allocated budget), and the like. Accordingly, the trained example Generative AI Model 300B generates an optimized recommendation 342 for the given user query 340.

Referring back to FIG. 2A, in some embodiments, the Knowledge Generator 206 is able to receive intent inferences from the Intent Inference Engine 204 and generate various units, such as, taxonomies, intent derivatives, spatial models, geometry computations, temporal computations, and object definitions for the AEC smart constructs that are to be built for the construction project. Taxonomies are generated based on introspection of data in a combinatorial fashion and evaluated for underlying word semantics. For example, the Knowledge Generator 206 is able to generate one or more spatial models for one or more chimneys, one or more windows, one or more doors, one or more elevations, one or more shapes, and the like, for the AEC smart constructs, and derived from the intent inferences. Further, the Knowledge Generator 206 is able to provide one or more design and operation related aspects of the AEC smart constructs that are to be built. Once the intent inferences are received, the above-discussed functionalities are provided by the Knowledge Generator 206 as discussed in the description of FIG. 4 below.

Referring to an example Knowledge Generator 206 in FIG. 4, that receives the user intent inferences from the Intent Inference Engine 204, the example Knowledge Generator 206 is able to include various modules, such as, taxonomies module 402, intent derivatives module 404, spatial models module 406, geometry computations module 408, temporal computations module 410, and object definitions module 412. The example Knowledge Generator 206 of FIG. 4 is similar in design and operation to the Knowledge Generator 206 as shown in FIG. 2A.

In some embodiments, the taxonomies module 402 is able to be configured to classify the derived intent inferences, with the resulting catalog used to provide a conceptual framework for discussion, analysis, or information retrieval. In some embodiments, the taxonomies module 402, while classifying the intent inferences, is able to be configured to consider the importance of separating elements of a group (taxon) of intent inferences into subgroups (taxa) that are mutually exclusive and unambiguous, and taken together, include all possibilities. The taxonomy provided by the taxonomies module 402 is simple, easy to remember, and easy to use.

In some embodiments, the intent derivatives module 404 is able to be configured to change the derived intents (and thus the intent inference) in relation to a change in an underlying, which is a variable, such as a user input. The intent is able to change when the user changes his/her previously provided input with respect to one or more elements of a construction project and provides new input(s).

In some embodiments, the spatial models module 406 module is able to provide virtual models in spatial domain of one or more constructs of the construction project that are derived using one or more machine intelligence, smart knowledge assembly, AI, ML, and cognitive techniques and are based on intent inferences. In an example, the spatial models module 406 is able to facilitate the user to see virtual models of constructs and select one among the many constructs of the construction project. In an example embodiment, the system 200A is able to recommend that instead of two windows to suit a given space, there should be three windows of specific dimensions and of specific spatial attributes (for example, design, orientation, and the like) to suit the space. Also, the type of material used is able to be determined according to how the space and geometric attributes are being formulated by the system 200A. The selection is able to be made in combination with the project objectives which are multi-criterion. Examples of the project objectives is able to include, but are not limited to, cost, time, material, labor, sustainability and the like.

In some embodiments, the geometry computations module 408 is able to be configured to provide geometric computations associated with one or more AEC constructs of the construction project. The geometry computations are associated with the optimal utilization of a given spatial dimension. For example, what types of geometrical attributes of an artifact would work best for a construction project. The geometric attributes are able to be a shape (such as oval, rectangle, or a square shaped geometry for a given artifact) and computed optimal dimensions of the given artifact.

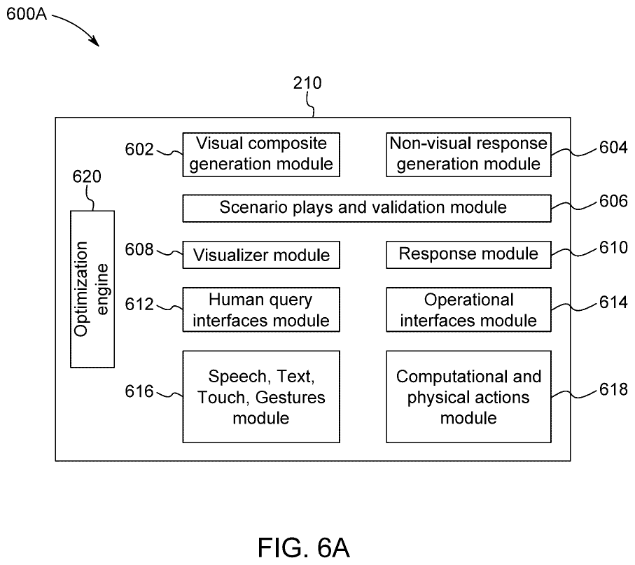

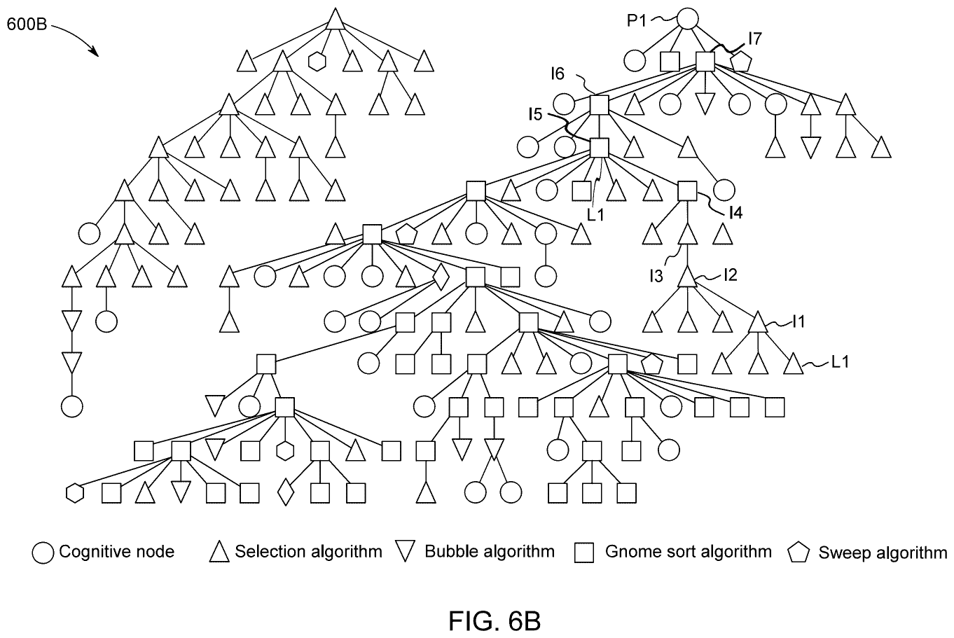

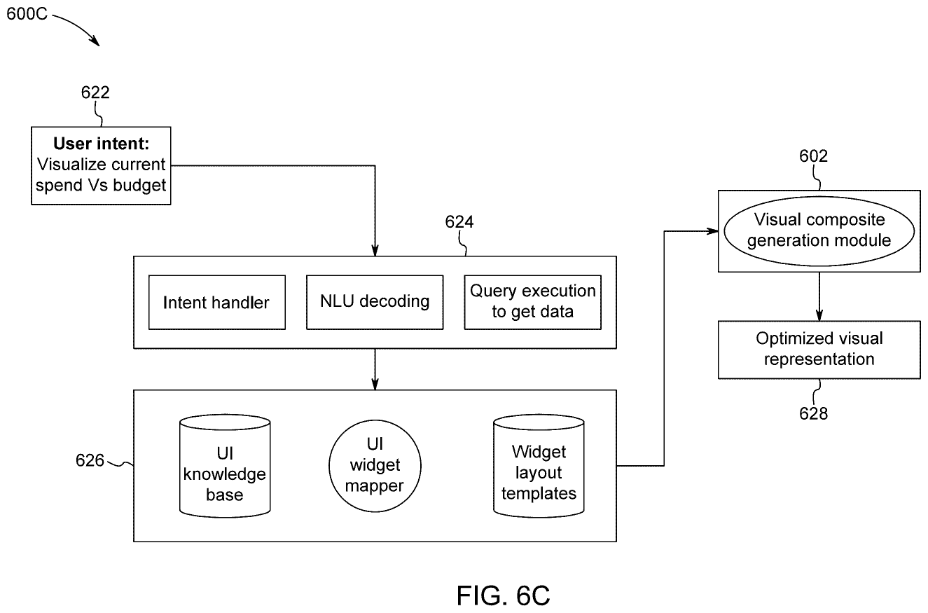

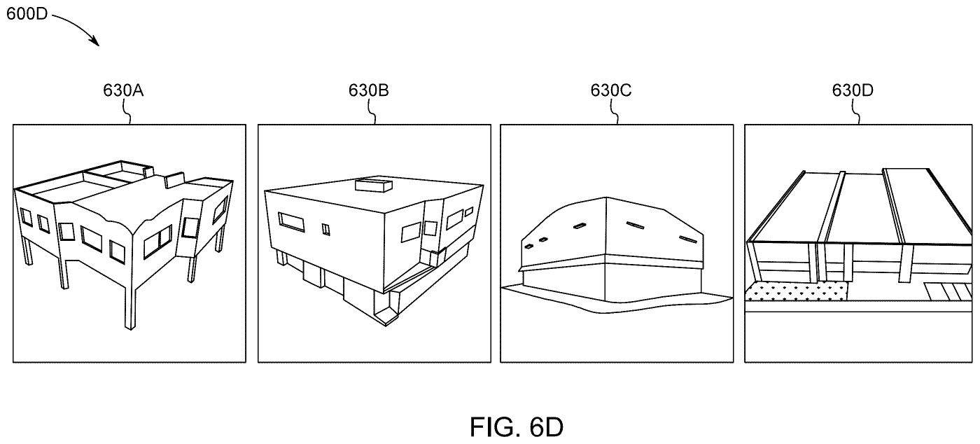

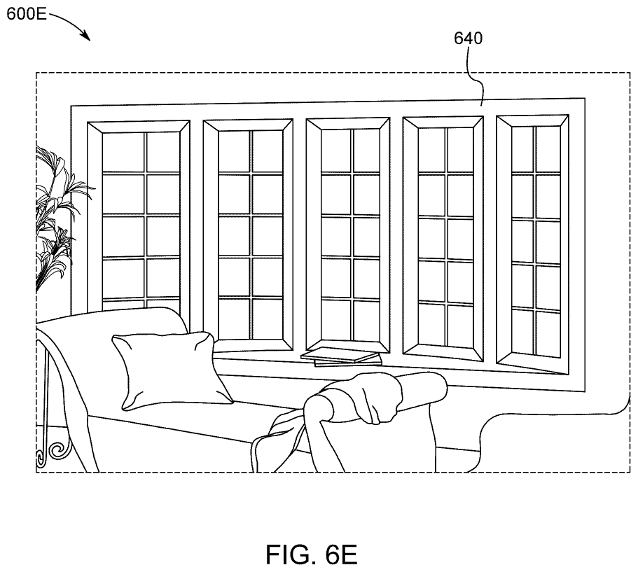

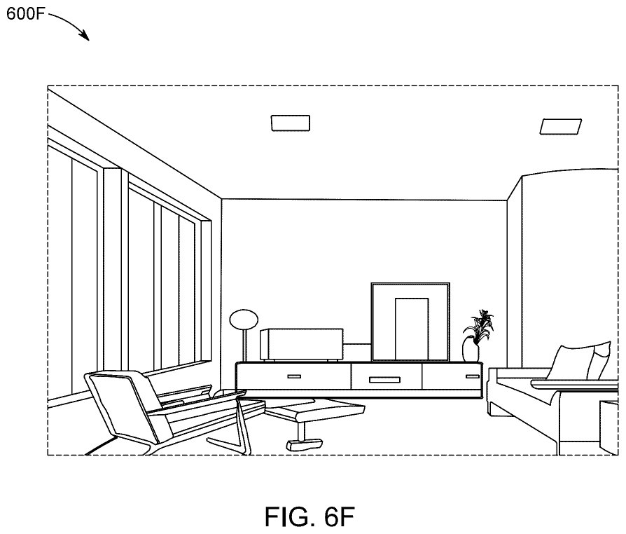

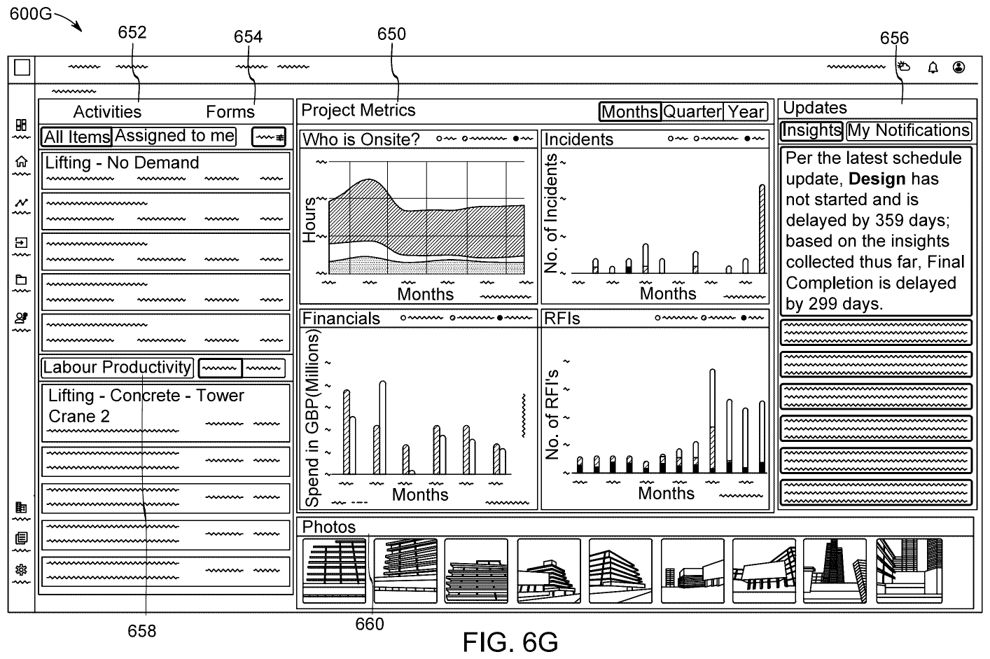

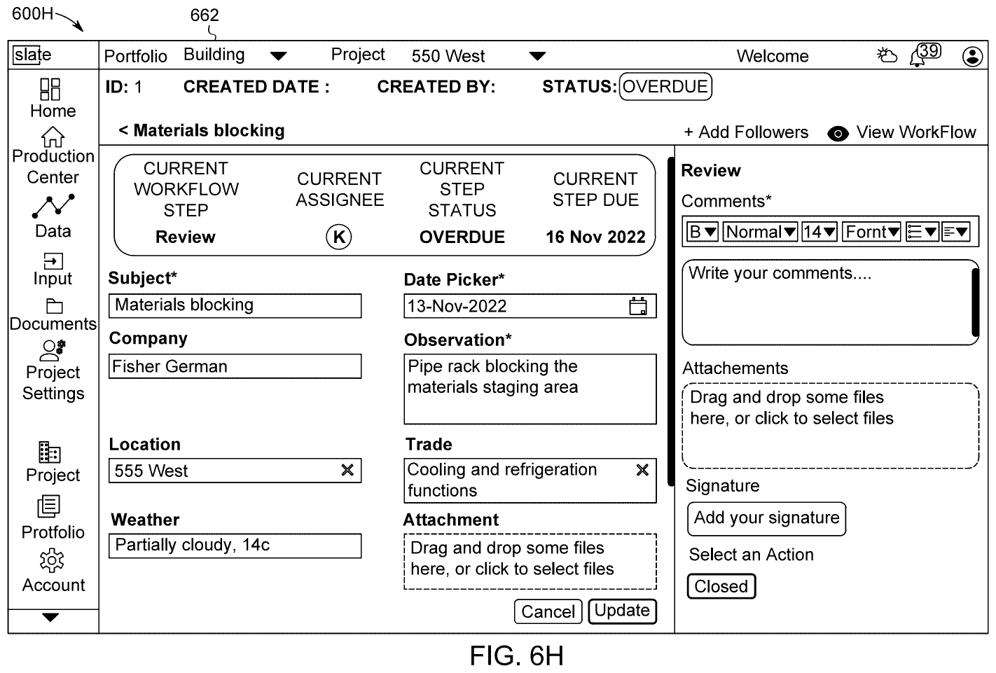

In an example, the geometry computations module 408 is able to ensure that the constructs generated using the intent inferences (through the usage of AI, ML, and/or cognitive techniques) satisfy the project requirements (with reference to geometry of the construction project) as set forth by the user and/or a project engineer and/or an architect of the construction project. In an example, the construction project has a predefined cost and time objectives, the construction project has to be completed in a given time and within a given cost. The optimization engine 620 (FIG. 6A) ensures that multiple simulations are performed to fit within the defining parameters to reach optimal outcomes. In certain cases, there may be options that exceed the cost objectives, or the time objectives as determined by the Geometry Computations Module 408. Such options are able to be removed from the system recommendation.

In some embodiments, the temporal computations module 410 is able to be configured to provide the temporal (time) computations associated with one or more constructs of the construction project. In an example, the temporal computations module 410 is able to ensure that the constructs built using the intent inferences (through the usage of AI, ML, and/or cognitive techniques) satisfy the project requirements (with reference to timelines of the construction project) as set forth by the user and/or project engineer and/or the architect of the construction project.

In some embodiments, the object definitions module 412 is able to be configured to define and recognize various AEC constructs (such as, objects) of the construction project which are generated using intent inferences (through the usage of AI, ML, and/or cognitive techniques). Object definition is able to allow robots and AI programs to derive and define AEC constructs of a construction project from intent inferences.

The above-discussed functionalities of the Knowledge Generator 206 are provided to the Knowledge Mapper 208.

Referring back to FIG. 2A, in some embodiments, the Knowledge Mapper 208 is able to receive various functionalities from the Intent Inference Engine 204 and generate objective evaluations, system inputs, correlation maps, sequence compositions, comparative pairings, and knowledge assemblies related to the AEC smart constructs that are to be built. In some embodiments, the Knowledge Mapper 208 is able to utilize the one or more databases for storing information regarding the objective evaluations, system inputs, correlation maps, sequence compositions, comparative pairings, and knowledge assemblies related to the AEC smart constructs. In some embodiments, the Knowledge Mapper 208 is able to store information related to conversational queries and construct generation. In some embodiments, the conversational queries are able to be similar to prompts, however, instead of each prompt being a standalone query, the system 200A employs interactive dialogues. The answer to a second conversational query is able to depend on the nature and content of the earlier question, its answer, and the user response.

Referring to an example Knowledge Mapper 208 in FIG. 5A, that receives the functionalities from the Knowledge Generator 206, the example Knowledge Mapper 208 is able to include various modules, such as objective evaluations module 502, system inputs module 504, correlation maps module 506, sequence composer module 508, comparative pairings module 510, and knowledge assemblies module 512. The example Knowledge Mapper 208 of FIG. 5A is similar in design and operation to the Knowledge Mapper 208 as shown in FIG. 2A.

In some embodiments, the objective evaluations module 502 module is able to be configured to evaluate objectives constraints associated with the constructs of the construction project from the derived intent inferences. For example, a construction project has a finite and fixed cost attribute. Any system recommendation is to fit within the bounds of this objective and evaluated for maximized returns within that set project objective. Other project objective constraints are able to include time constraints. In all, the system factors in all project/project objective and mandates and performs evaluations and optimization to fit within such bounds. In an example, the project objectives are able to be related to cost, timelines, and sustainability of the one or more constructs associated with the construction project. The objective evaluations module 502, after evaluating the project objectives, is able to suggest if the construction project is viable or not. The suggestion is able to be based on cost, timelines, project margins and sustainability objectives. Upon evaluation by the objective evaluations module 502 to formulate recommendations, the system 200A at times is able to offer a recommendation not to proceed with the construction project based on the computations and the return on investments being non-existent or counter-productive.

In some embodiments, the system inputs module 504 module is able to be configured to process inputs (related to one or more objectives of the construction project) received from one or more systems other than the system 200A and check whether the intent inferences need any update in view of the processed inputs. In some embodiments, the inputs are able to be verbal, textual, dialogues, and/or user gestures, such as touch, click, or an interaction on a graphical interface. The inputs are able to be both visual, auditory, and explicit user actions. In an example, the system inputs module 504 is able to be configured to modify the intent inferences in their entirety.

In some embodiments, the correlation maps module 506 is able to be configured to provide and store (in a database) a mapping between the generated (derived) intent inferences and one or more project objectives of a construction project indicated by one or more systems other than the system 200A. Such correlations are able to be utilized to generate a knowledge graph that is used for subsequent feedback and analysis in the system 200A. In addition, the correlation maps module 506 is able to be configured to provide and store (in a database) a mapping between the generated intent inferences and one or more constructs of a construction project (which are generated from the intent inferences). Correlational knowledge graph with sequence of optimal events is a major advantage in the system 200A that provides recommendation based on evaluation of apriori knowledge.

In some embodiments, the sequence composer module 508 is able to be configured to compose and indicate a sequence of events involving the generated constructs of the construction project that will be taking place in a project timeline of the construction project. The sequence of events is able to be an order in which certain construction activities are to take place which is able to move the system progress towards optimal project milestones. The sequence of events is able to be composed based on internal system simulations of certain events happening in the present and future and based on historic trails. The sequence of events is able to be indicated using visual illustrations, such as sequence diagrams, Gant Activities, a report, and the like. The sequence composer module 508 is able to be configured to indicate said sequence to the user.

In some embodiments, the comparative pairings module 510 is able to be configured to build pairs of intent inferences and constructs of the construction project for a comparative analysis. In some embodiments, the comparative pairings module 510 is able to be configured to analyze and provide a construct (from amongst a group of constructs) that closely corresponds to a generated intent interference. In doing so, the comparative pairings module 510 is able to use one or more machine intelligence, smart knowledge assembly, AI, ML, and cognitive techniques.

In a composite system, multiple AI agents/Models analyze the user intent, each performing an interpretation of it to suit project objectives, as illustrated in FIG. 5B. Referring to FIG. 5B, there are shown computational models 520 and 540. The computational models 520 and 540 are executed based on two different AI agents/Models, respectively. A first AI agent/Model is able to work towards cost optimization based on the user intent and the other AI agent/Model is able to work towards schedule optimization based on the same user intent. More specifically, in the first computation model, at a step 522, a first AI agent/Model analyzes/evaluates the user intent based on the user inputs. At a step 524, project objective constraints are determined based on evaluation of a first objective, such as predefined cost of a construction project, provided by the user. At a step 526, simulations are performed using current and directional future trends leveraging on the associated knowledge units. Such knowledge units are able to act as foundational units upon which future simulations are able to easily leverage upon to generate intelligent recommendations. Knowledge units have been described in detail in FIG. 5C. At a step 528, multiple optimal paths are prepared. At a step 530, path sequence with maximized ROI based on optimized cost is able to be selected. Similarly, in the second computation model, at a step 542, a second AI agent/Model analyzes/evaluates the user intent based on the user inputs. At a step 544, project objective constraints are determined based on evaluation of a second objective, such as predefined schedule of the construction project, provided by the user. At a step 546, simulations are performed using current and directional future trends leveraging on the associated knowledge units. In the case of new simulations, new knowledge units are generated, as described in FIG. 5C. At a step 548, multiple optimal paths are prepared. At a step 550, a path sequence with maximized ROI based on optimized schedule is able to be selected. Multiple outputs, as generated by multiple AI agents/Models are able to be combinatorically analyzed and comparatively evaluated by supervisory algorithms, as described in the Evaluation Model 600B in FIG. 6B. Accordingly, optimal recommendations are able to be generated.

In some embodiments, the knowledge assemblies module 512 is able to be configured to store the generated knowledge associated with one or more of the intent inferences, generated constructs of the construction project, and project objectives provided by one or more systems other than the system 200A. The knowledge assemblies module 512 is able to function as a universal database that is operable to store all the data related to the construction project as knowledge units, as further described in FIG. 5C.

Referring to FIG. 5C, there are shown two knowledge units 560A and 560B. The first knowledge unit 560A includes a plurality of nodes N1 to N5 that correspond to data/intent synthesized nodes. One of the nodes, such as N5, corresponds to the first objective, such as predefined cost of a construction project. The first knowledge unit 560A illustrates multiple paths from different nodes, for example, (N1->N2->N5), (N1->N3->N5), and (N1->N4->N5), to reach node N5, the first objective node. Similarly, the second knowledge unit 560B includes a plurality of nodes N10 to N15 that also correspond to data/intent synthesized nodes. One of the nodes, such as N15, corresponds to the second objective, such as predefined schedule of the construction project. The second knowledge unit 560B illustrates multiple paths from different nodes, for example, (N10->N11->N14->N15), (N10->N13->N14->N15), and (N10->N12->N15), to reach node N15, the second objective node. Such knowledge units 560A and 560B, as determined by the Knowledge Mapper 208 are provided to the Generative Optimizer 210.

Referring back to FIG. 2A, in some embodiments, the Generative Optimizer 210 is able to utilize the functionalities provided by the Knowledge Mapper 208 and is configured to generate analytics, strategies, and actions related to the AEC smart constructs that are to be built. The Generative Optimizer 210 is able to generate a visual composite of a virtual representation, a non-visual composite of the virtual representation, a scenario play and validation of the virtual representation, responses to queries on the virtual representation, a human query interface, an operational interface, a speech, a text or touch gestures, and a computational and physical action (actions on entities, emails, call, text, and the like) related to the AEC smart constructs that are to be built. In some embodiments, the Generative Optimizer 210 is able to use one or more machine intelligence, smart knowledge assembly, AI, ML, and cognitive techniques for implementing the above-discussed functionalities related to the AEC smart constructs.

Referring to an example of the Generative Optimizer 210 in FIG. 6A, that receives the functionalities from the Knowledge Mapper 208, the example Generative Optimizer 210 is able to include various modules, such as visual composite generation module 602, non-visual response generation module 604, scenario plays and validation module 606, visualizer module 608, response module 610, human query interfaces module 612, operational interfaces module 614, speech, text, touch, and gestures module 616, computational and physical actions module 618, and optimization engine 620. The example Generative Optimizer 210 of FIG. 6A is similar in design and operation to the Generative Optimizer 210 as shown in FIG. 2A.

In some embodiments, the visual composite generation module 602 is able to be configured to generate visual composites for the one or more constructs (generated from intent inferences) in order for a user to view and select a construct from amongst the one or more constructs made visually available by the visual composite generation module 602. For example, as illustrated in FIG. 6C an example use case 600C is illustrated for generating an optimized visual representation, the user is able to query the system 200A to compose a visual for budget vs current spend. At block 622, the user intent is analyzed to visualize budget vs current spend by the Intent Inference Engine 204. At block 624, the user intent is handled, the uttered phrase is understood (using inferred Natural Language decoding), and one or more user queries are executed by various modules of the Intent Inference Engine 204. Thereafter, the visual composite generation module 602 is able to refer to the disparate data sources 106 and/or the intelligent warehouse 108, collectively represented by the block 626, for determining user interface (UI) knowledge base, UI widget mapping, and various widget layout templates. Further, the visual composite generation module 602 is able to receive inputs, such as apriori knowledge and knowledge graph, from the correlation maps module 506. Accordingly, the visual composite generation module 602 is able to create visual objects, such as 2d and 3d composites, as the optimized visual representation 628. The visual representation 628 is able to include various designs, such as construction models, 2D and 3D architectural illustrations. Examples of the visual representation 628 are described as visual recommendations 600D, 600E, and 600F as illustrated in FIGS. 6D, 6E, and 6F, respectively. Further, the visual composite generation module 602 is able to also compose 2d and 3d composites, such as UI widgets to be assembled in a dashboard, visuals that represent visual artifacts, such as chart-like interface, and the like. Examples of such visual representation 628 are described as dashboards 600G and 600H as illustrated in FIGS. 6G and 6H, respectively.

Referring to FIG. 6D, there are shown different visual recommendations 600D of an example building structure generated by the disclosed system 200A, according to some embodiments. In such embodiments, the user input is able to correspond to “Create a construction project schedule for an electrical work package for a multistory (in an example, two-story) building.” In response, the disclosed system 200A is able to recommend different designs 630A to 630D while factoring in the geography for the required two-story building. In addition, the disclosed system 200A is able to tap into its domain knowledge in terms of the construction and the kind of material that needs to be used given the topography and geography for the substructure (of the building structure), local regulatory requirements, and other constraints and factors that may impact the construction of such a building.

Referring to FIG. 6E, there are shown a visual recommendation 600E of an example window panel generated by the disclosed system 200A, according to some embodiments. In such embodiments, the user input is able to correspond to “Require a window that would fit a 5 ft×5 ft opening.” The system 200A is able to generate the suggestions based at least on minimal user input and intent describing the user requirements in the form of the given scenario. In other words, the system 200A is able to simulate optioneering (for one or more elements of a building) to fit the design wishes of the user. For example, the user is able to refer to a building composed of the system 200A and a particular window panel in the building design, and request suggestions that could work for this particular window panel. The disclosed system 200A is able to respond by providing a fully functional and mature design of the window frame, for example, the kinds of substructures that would satisfy the user intent and design. The internal processing by the computational system is able to include evaluation of spatial information, geometry of a desired space (for example, factory assembly for the room), the utilitarian intent of the given space, the number of human occupants, the locale governing regulations, and the like. Thus, as illustrated in FIG. 6E, the disclosed system 200A provides a recommendation of an example window panel 640 in accordance with some embodiments. In some embodiments, the system 200A is able to further refine the proposed designs based on additional user inputs. The additional user input is able to be in the form of an interactive dialogue with the system 200A and with each user input, the system 200A is able to reconfigure and refine its earlier designs to suit user intent and preferences.

Referring to FIG. 6F, there is shown a visual recommendation 600F of an example design of a room generated by the disclosed system 200A, according to some embodiments. In such embodiments, the user input is able to correspond to “Design a living room”. The system 200A is able to compose several designs in accordance with the use of the room (for example, living room vs. office room) and presents an optimized visual recommendation 600F to the user. The internal processing by the computational system is able to include evaluation of spatial information, geometry of a desired space, cultural preferences of the user, and the like.

Referring to FIG. 6G, there is shown a first dashboard 600G generated by the disclosed system 200A, according to some embodiments. The first dashboard 600G is able to include project metrics 650 corresponding to number of hours spent per month by employees, labor, and trade, incidents happening per month, financials (expenditure per month), and month-wise RFIs. The first dashboard 600G is able to further include insights about various activities 652, forms 654, updates 656, labor productivity 658, and a collage of photos 660, to name a few.

In some embodiments, the system 200A is capable of reviewing a dashboard, such as the first dashboard 600G, that has various project metrics 650, such as, productivity metrics, number of employees on site based on trade, contractors, employees, number of incidents, any accidents on the site, monetary implications of certain events, financials, budget and spend, and other impediments in the project, to name a few. The system 200A is able to further evaluate the first dashboard 600G composites. For example, the System is able to analyze planned versus actual effort and compute the makeup effort needed. The system 200A is able to further generate a UI widget automatically to highlight such a scenario and send appropriate alerts. The disclosed system 200A is able to understand any number of available analytical widgets. In an example, based on the labor productivity 658, the system 200A is able to understand the intent in terms of the planned work, such as, a task that should have been completed with 151 man-hours, but has taken 483 man-hours with the net result being degraded productivity. In some embodiments, the first dashboard 600G is able to include the collage of photos 660 of the real time status of a construction project, sets of activities, forms, notifications, and the like.

In a normal human interaction, a user must have apriori knowledge of the construction projects, and sufficient understanding of the various aspects to comprehend and interpret the metrics and visual artifacts presented in a dashboard, for example, the first dashboard 600G. However, in some embodiments of the disclosed system 200A, the user is able to simply query the system 200A, for example, ask “Tell me about this project”, as a user input. The system 200A then synthesizes various information and provides the user with pertinent information. For an interaction on project updates, the system 200A is able to process the construction phase and stage, the user's role, and data privilege in the system 200A, weather feeds, images collected from the files or various databases and analyzed through Machine Vision, financial data from relevant systems, live IoT (Internet of Things) data feeds from various equipment in the field, the overall project schedule, and nearest milestones. Accordingly, the system 200A is able to triangulate such collective data to look for progress impediments and avenues for efficiency improvements and convey the result to the user in a concise form. The system 200A is able to use polyglot data persistence and retrieval mode to process disparate data sets, is able to compare the user intent and what was already conveyed to the user and is able to provide additive, and users interested information in the order of priority for project execution. For example, the system 200A is able to not only be able to convey that the labor productivity in the current project is less by, say X manhours, but the causality of the low labor productivity and the reason why the labor productivity is low, as well as a comparison of the current project productivity with the productivity that is typical in a similar project based on real-world information and the like. In the present disclosure, this additional information is not provided to the system 200A, but the system 200A is able to automatically tap into the project data source, into the data warehouse, such as the intelligent warehouse 108, or into any other data source from the disparate data sources 106. Accordingly, the system 200A is able to get all the productivity or the range of time taken for project completion, and then is able to compare with the outside world, whether it is in the public domain or elsewhere (for example, subscription data).

In some embodiments, the disclosed system 200A is able to understand and correlate the sourced data to interpret it within a given context. Further, to understand and correlate the sourced data, the system 200A is able to analyze published documents and create a synopsis of the whole project by understanding various nuances presented at the first dashboard 600G in a manner that is easier for the interactor to comprehend.

Further, the disclosed system 200A is intelligent to synthesize information (from the sourced data) that is based on the interacting user. For example, if the interacting user is an executive, the disclosed system 200A will decode or decipher the project status and provide a few key highlights that the executive needs to know (for example, financial status, cost overruns, quality issues, labor issues, site incidents, and the like). Further, the way the system 200A responds to a site supervisor is different from the way the system 200A responds to the executive. As the differentiation is based on a particular interacting user, different responses are able to be generated for different users. Further, in an example, if the interacting user is a site supervisor, the disclosed system 200A will provide more information about the productivity metrics, for example, why the productivity is high or low, what a particular contractor has to do for the next six weeks, and many other in-depth details. Because the intent or objectives for the site supervisor are quite different from that of the executive, the system 200A intelligently synthesizes the information in accordance with the interacting user and conveys the right set of data to the particular user in a manner the user will be able to understand and interact with the system 200A in an interactive dialoguing mode.

Referring to FIG. 6H, there is shown a second dashboard 600H generated by the disclosed system 200A, according to some embodiments. In some embodiments, the system 200A is able to comprehend a number of artifacts related to a particular project, such as forms and documents. The forms are able to be related to particular incidents or notes on the construction project status, for example, an observation form 662 that indicates that a pipe rack is blocking the materials staging area. The system 200A understands this observation and is able to determine the potential impact of this observation on the overall project progress. The second dashboard 600H illustrates the observation form 662 that is able to indicate that a pipe rack is blocking a materials staging area. The observation form 662 is able to include various fields, such as subject, company, location, weather, date picker, observations, trade, and review, to name a few.

The disclosed system 200A is able to review and ingest documents related to the construction project from a document repository (that is available to it). For example, the procurement contract for a project is able to be a multipage document potentially running into hundreds of pages with different sections, connotations, and other details. The system 200A is capable of synthesizing or creating a synopsis of the information and presenting it in a manner that is relevant to the interacting user. For example, the system 200A is able to review the contract obligations (e.g., from an RFI form) and understand the content of the observation form 662 and infer the potential impact of the pipe rack blocking the materials staging area. The system 200A is able to inform the appropriate interacting user that the block may impact the schedule, such as, the ability to complete the task and therefore, the net impact could be a loss of X days or the loss of Y amount of dollars. Thus, the system 200A is able to read the documents how a human being would read and correlate this learned information with other information (internal or external to the project) and determine the impact on more than just one aspect of the construction project. That is, the system 200A performs a combinatorial analysis of various events going on in the construction project and provides proactive and actionable insights.

In some embodiments, the intelligent warehouse 108 is able to include a document database that stores documents that are subjected to a human being reviewing the document, for example, if the document is a regulatory compliance document or an approval document, the people involved in the construction project have to review and approve them. The documents are able to be uploaded on the system 200A or include system generated documents. Besides these, for knowledge accrual, there are able to be any number of other documents in the public domain or in paid repositories. The disclosed system 200A has the ability to learn everything that has ever been produced and by humanity over the last ‘X’ number of years and apply the learning to the current context by locating other relatable documents, artifacts and the like, that will be helpful that is not necessarily in any construction project data repository.

Referring back to FIG. 6A, in some embodiments, the non-visual response generation module 604 is able to be configured to generate non-visual composites (such as audio, text-based composites) for the one or more constructs (generated from intent inferences) in order for a user to analyze and select a construct from amongst the one or more constructs made available by the non-visual response generation module 604. In an example, the non-visual composite is able to be an auditory response from the non-visual response generation module 604.

In some embodiments, the scenario plays and validation module 606 is able to be configured to play and validate the scenarios associated with one or more constructs of the construction project. In an example, the scenario plays and validation module 606 is able to play and validate a timeline associated with a construct of the construction project. In another example, the scenario plays and validation module 606 is able to generate multiple what-if scenarios, champion-challenger scenarios, and come up with multiple simulations for a given scenario. While doing so, the scenario plays and validation module 606 is able to use one or more machine intelligence, smart knowledge assembly, AI, ML, and cognitive techniques.

In some embodiments, the visualizer module 608 is able to be configured to facilitate visualization of one or more constructs of the construction project for the user. In an example, the visualizer module 608 is able to facilitate in assembling multiple UI components into a cohesive visual artifact that is able to be a representation of a real-world artifact. In an example, the visualization is able to be realized virtually such that the user may have a look at the constructs while sitting at any location that is remote and far away from the actual construction project site location.

In some embodiments, the response module 610 is able to be configured to provide responses on queries related to the user intent, intent inferences, and/or generated constructs. In an example, the response module 610 is able to provide the one or more responses in a visual form or in a non-visual form that is understandable by the user. In other examples, the response module 610 is able to facilitate an appropriate system response to user inputs in the form of interactive dialoging, dashboard directives and audio response, as examples.

In some embodiments, the human query interfaces module 612 and operational interfaces module 614 are able to be configured to provide interfaces for putting forth human queries and indicating operational queries, respectively, to the system 200A. The interfaces are non-limiting in nature and are able to be any interface that is known in the art. In an example, the human query interfaces module 612 is able to facilitate natural human conversations of the user with the system 200A. In another example, the operational interfaces module 614 is able to enable data and database interfaces.

In some embodiments, the speech, text, touch, and gestures module 616 is multi-modal enabled and is able to be configured to handle an interaction of the user with the system 200A. The speech, text, touch, and gestures module 616 is able to facilitate a user to play around with the virtually generated one or more AEC constructs of the construction project. In an example, the user is able to speak or send text to the system 200A seeking details on the one or more virtually generated AEC constructs of the construction project. Further, in an example, the user is able to touch, feel, and provide gestures for the one or more virtually generated AEC constructs of the construction project.

In some embodiments, the computational and physical actions module 618 is able to be configured to facilitate the user to take actions associated with one or more virtually generated AEC constructs of a construction project in response to a user intent, query, or a system action. The actions are able to include actions associated with emails, calls, events, or text associated with the one or more virtually generated AEC constructs. In an example, the action is able to be associated with the computational aspects of the one or more virtually generated constructs. In another example, an action is able to modify one or more aspects associated with the one or more virtually generated constructs.

In some embodiments, the optimization engine 620 is able to be operable to optimize the functionalities (associated with one or more constructs of a construction project generated from intent inferences) such that the functionalities closely match the user input 220 associated with the user communicating with the system 200A. One such optimization functionality is able to be combinatorial analysis and comparative evaluation when multiple outputs are generated by multiple AI agents/Models, as described in FIG. 5B. In some embodiments, such combinatorial analysis and comparative evaluation for multiple outputs is able to be performed by supervisory algorithms to generate optimal recommendations, as described in FIG. 6B. While doing so, the optimization engine 620 is able to use one or more machine intelligence, smart knowledge assembly, AI, ML, and cognitive techniques that provide the best possible results.

Referring to FIG. 6B, there is illustrated an Evaluation Model 600B that depicts multiple AI agents, such as, self-learning, supervised, and Human-in-the-loop agents/models in an ensemble mode at leaf nodes of the tree that represents the Evaluation Model 600B. The Evaluation Model 600B is enabled with supervisory model evaluation and processing capabilities (e.g., GPU farms) to process and synthesize information to generate recommendations. A fusion of future prediction of each individual model feature, for example, anticipated economic influences, visual introspection of land topography, and climatic changes, that may influence the construction project, are able to be generated. The Evaluation Model 600B is able to use multi-modality, that is, various types and veracity of data sources that it is able to self-generate, for its computation. AI-based colonizers and captive agents are able to swarm to a combination of desired objective achieving targets. Some AI agents are able to predict the future coefficients for such scenarios, and some are able to contest the outcome of a group of agents to generate an output. A combinatorial analysis of these outputs is then able to be evaluated for correlation influences, examined, and compared with the project objectives to make the recommendations that meet the project objectives. The Evaluation Model 600B is also able to analyze the relationships and correlation between the various input data streams to determine if such relationships and correlations are relevant and if the data is relevant, is there a revelation behind it, that is, is there a causality behind it.

As illustrated in the Evaluation Model 600B in FIG. 6B, a variety of AI agents are shown as nodes, represented by leaf nodes ‘L1’, the outputs of which are analyzed in combination and then are evaluated at nodes, represented by intermediatory nodes ‘I1’ to ‘I7’, for correlation influences, examined, and compared with the project objectives to make an optimal recommendations indicated by the topmost node, represented by a parent node ‘P1’. For ease of understanding, different shapes of nodes correspond to AI nodes implementing different algorithms. For example, round-shaped cognitive nodes correspond to the AI agents implementing cognitive techniques to introduce human experience notion in addition to the historic data. Further non-limiting examples are able to include triangle-shaped nodes that correspond to AI agents implementing correspond to selection algorithms, inverted-shaped triangle nodes that correspond to AI agents implementing bubble algorithms, square-shaped nodes that correspond to AI agents implementing gnome sort algorithms, and pentagon-shaped nodes that correspond to AI agents implementing sweep algorithms, to name a few.

Referring back to FIG. 2A, in some embodiments, the Construct and Interaction Generator 212 is able to be configured to generate various construct and interactive sessions with a user associated with the user input 220. In some embodiments, the construct and interactive sessions are able to correspond to the system 200A providing responses to the queries put forth by the user in relation to the functionalities provided by the Generative Optimizer 210. As an example, a query is able to be to know which AEC smart construct from the virtual models (of the AEC smart constructs) generated by the Generative Optimizer 210 is best suited for being environment friendly. The Construct and Interaction Generator 212 is able to use one or more machine intelligence, smart knowledge assembly, AI, ML, and cognitive techniques while conducting sessions related to the AEC smart constructs. Once one or more sessions are complete, the generated virtual representations of the AEC smart constructs are operationalized virtually by the Operationalizer 214.

In some embodiments, the Operationalizer 214 is able to virtually operationalize the generated virtual representations of the AEC smart constructs. In some embodiments, the term “virtually operationalize” means operationalizing (knowing the functioning of) the generated virtual representations of one or more constructs of a construction project. In other words, the generated virtual representations are analyzed, and their corresponding operation is seen and tested in virtual reality or augmented reality. In some embodiments, the generated virtual representations of the AEC smart constructs are able to be operationalized virtually to facilitate monitoring of the efficiency related to the generated virtual representations of the AEC smart constructs.

In some embodiments, the Efficiency Monitor 216 is able to implement the functionality of monitoring the efficiency related to the generated virtual representations of the AEC smart constructs. In some embodiments, monitoring the efficiency is able to result in the system 200A indicating one or more virtual models, amongst the virtual models of the AEC smart constructs, that are cost effective, environment friendly, and time sensitive. Thus, the system 200A provides virtual models (or virtual representations) for the AEC smart constructs while simultaneously indicating the best ones that are able to be practically implemented (in an example, best in terms of cost, completion time for implementation and build, environment and the like).

FIG. 2B illustrates an example computational system 200B for implementing the system 200A, according to some embodiments. Illustrated in the computational system 200B are the client computing device 104, the disparate data sources 106, and the intelligent warehouse 108 providing required inputs to the system 200A that are able to be implemented in, for example, the server computing device 102. The system 200A is able to be trained by a training module 224. The output of the system 200A is able to be provided to a recommendation engine 226 that is able to provide intelligent recommendations 228 as one or more virtual representations of the AEC constructs at a display device, such as the monitor 118 of the server computing device 102. Various modalities of the intelligent recommendations 228, such as, the one or more virtual representations, have been described in FIGS. 6D to 6H.

In some embodiments, the user input 220 is able to be in form of “user intent” determined or otherwise generated by the server computing device 102 based on the user input and/or information from the intelligent warehouse 108. In some embodiments, the user input 220 is able to be in form of a query provided by the user using an interface (for example, a Graphical User Interface) of a computing device, for example, the client computing device 104. In certain cases, the user input is able to correspond to one or more project objectives associated with a construction project. In other cases, the user input is able to indicate an intent of the user. The user intent is able to be a design intent (for example, how good, valid and optimal is the current design related to the elements, geology and objectives of cost, schedule optimization and other objectives, such as, sustainability), a temporal intent (for example, how effective is the design and the schedule as it relates to the time notion and how effective the schedule is able to be in meeting time objectives), a spatial intent (for example, how good are the operational constructs as it relates to optimization of space and how effective a design is able to be in utilizing a given space), and a geometrical intent (for example, how effective are the shapes both exposed and internal for structural integrity, inhabitant comfort and an ability for implementation). In some embodiments, the user intent is able to further include cultural intent, such as preference for Vaastu, Feng Shui, and the like. However, the user intent is able to not be limited to the design, temporal, spatial, and geometrical intents, but is also able to include some of the others, such as fiduciary and legal intents.

Based on the user input 220, and in accordance with the project objectives 222 provided by the user or automatically determined by the system 200A based on the user input 220, the system 220A, in conjunction with the model ensemble 112, is able to intelligently create, manage, and execute AEC smart constructs based on the various modules, as described above in FIG. 2A in a given construction environment. The model ensemble 112 is able to include multiple models, such as classifiers or experts, strategically generated and combined to solve a particular computational intelligence problem. Ensemble learning is primarily used to improve the (classification, correlation, function approximation, for example) performance of a model, or reduce the likelihood of an unfortunate selection of a poor one. In an example, an ML model selected for correlating disparate construction data streams is different from an ML model required for processing a statistical input for sensitivity. The model ensemble 112 is able to include machine learning techniques, deep learning techniques, neural networks, deep learning with hidden layers, or a combination of these techniques.

The training module 224 is able to be configured to train the one or more ML models used by the system 200A for generating the intelligent recommendations 228. The one or more ML models are able to be trained on a training data set generated or otherwise provided by the training module 224 using a supervised and/or unsupervised learning method. The one or more ML models are able to be run with the training data set to adjust the parameter(s) of the models. In some embodiments, the training module 224 is able to be continuously updated with additional training data obtained within or outside the network computing system 100. The training data is able to comprise factual data and human cognitive factors associated with the user and the AEC smart constructs. The trained machine learning model is applied to the user input 220 received from the user for the inference of the user intent for executing at least one intended task by the user. The user intent is able to be classified as at least one of: a design intent, a temporal intent, a spatial intent, a geometrical intent, and a cultural intent. The training data is able to further include historic user/customer data and synthetically algorithm-generated data tailored to test efficiencies of the different machine learning and/or artificial intelligence models described herein. Synthetic data is able to be authored to test a number of system efficiency coefficients. This is able to include false positive and negative recommendation rates, model resiliency, and model recommendation accuracy metrics. An example of training data set is able to include data relating to task completion by a contractor earlier than a projected time schedule. Another example of training data set is able to include data relating to modifications made by a user on an established link. Another example of a training data set is able to include several queries on construction projects received over a period of time from multiple users as user inputs. Yet another example of a training data set is able to include a mapping between queries and associated user intent for each query. Thus, the training module 224 is able to iteratively train and/or improve the one or more machine learning and/or artificial intelligence models employed by the system 200A.

Accordingly, the recommendation engine 226 generates various intelligent recommendations 228 associated with the construction project as the one or more virtual representations. In some embodiments, the intelligent recommendations 228 is able to be presented in an operative mode, in conjunction with scenario plays and validation module 606 and the speech, text, touch, and gestures module 616. Such a presentation in an operative mode is able to enable the user to play around with the virtually generated one or more constructs of the construction project. In an example, the user is able to speak or send text to the system 200A seeking details on the one or more virtually generated constructs of the construction project. In another example, the user is able to touch and provide gestures for the one or more virtually generated constructs of the construction project.

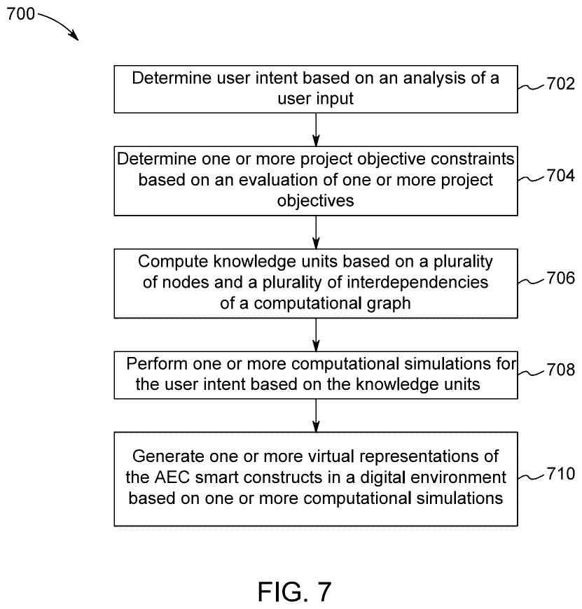

FIG. 7 illustrates a method for generating virtual representations of AEC smart constructs, according to some embodiments. FIG. 7 will be explained in conjunction with the description of FIGS. 1 to 6H.

At step 702, the system 200A and/or the controller 114 forming a part of the server computing device 102 is able to determine user intent based on an analysis of a user input, such as the user input 220 (FIG. 2B). In some embodiments the user input is able to be in the form of a query provided by the user in one or more of different modalities, for example, input text/speech 334 (FIG. 3C). In some embodiments, the user input is able to be in the form of an interaction scenario of a user with the disclosed system 200A. A few of non-limiting examples of the interaction scenario is able to be “Create a construction project schedule for an electrical work package for a multistory (in an example, two-story) building;” “Summarize current productivity metrics for a construction project;” “Synthesize specification documents related to regulatory compliance;” “Create a floorplan for a multistory (in an example, two-story) building;” “Create a window panel structure and implementation plan for floor to ceiling windows for a building of certain dimensions;” “Confirm if the processes are needed to be adopted for building completion certification;” though other interaction scenarios are also contemplated. The user is able to provide such user input to the system 200A and/or the controller 114 forming a part of the server computing device 102 via various input devices of the client computing device 104.

In some embodiments, the Intent Inference Engine 204 in the system 200A and/or the controller 114 forming a part of the server computing device 102 is able to infer user intent from the received user input 220 using one or more machine intelligence, smart knowledge assembly, AI, ML, and/or cognitive methodologies. In some embodiments, intent inferences are able to be determined through application of one or more logical rules to the user input 220 to evaluate and analyze new information. For example, a logical rule that is inferred and machine composed is able to be—If the phase of a construction project is an initial preconstruction phase and the user is asking the system 200A a query—“Update me on the Project”, the system 200A understands the user intent as a general update on permits, land preparation and allotted budget. However, if during the construction phase, if the construction project is facing delays and overruns, and the user asks the same query, at this time, the Intent Inference Engine 204 understands the criticality of the situation, and the intent is to find solutions to unblock the impediments. Based on the notion, the system 200A is able to state the impediments and resolutions and not go into a verbose articulation of the project updates.

In some embodiments, the evaluated and analyzed new information which is based on the application of the one or more logical rules to the user input 220 is able to be utilized as training data to train the machine learning model. The training data is able to comprise historical data, factual data, and human cognitive factors associated with the user and the AEC smart constructs. The trained machine learning model is applied to the user input 220 received from the user for the inference of the user intent for executing at least one intended task by the user. The user intent is able to be classified as at least one of: a design intent, a temporal intent, a spatial intent, a geometrical intent, and a cultural intent.

At step 704, the system 200A and/or the controller 114 forming a part of the server computing device 102 is able to determine a plurality of project objective constraints based on an evaluation of one or more project objectives. In some embodiments, the project objectives, as exemplified in the forthcoming description, are a collection of different user requirements, project requirements, regulatory requirements, technical requirements, and the like, related to a construction project. Examples of such project objectives are able to include parameters for optimization of construction schedule to meet time objectives, optimization for cost objectives, optimization for carbon footprint objectives, which are normalized to factor in worker health, minimization of onsite workers, and minimization of quality issues. In some embodiments, the project objectives are able to be determined by the system 200A and/or the controller 114 forming a part of the server computing device 102 from the user input 220 and/or the user intent based on a natural language parser and a work tokenizer.

In some embodiments, as described in FIG. 5A, the objective evaluations module 502 module is able to be configured to determine a plurality of project objective constraints from the derived intent inferences based on an evaluation of one or more project objectives associated with the constructs of the construction project. Examples of the project objectives constraints associated with a project requirement objective are able to include cost constraint, timelines constraint, and sustainability constraint. The objective evaluations module 502, after evaluating the project objectives, is able to suggest if the construction project is viable or not.

At step 706, the system 200A and/or the controller 114 forming a part of the server computing device 102 is able to compute knowledge units based on a plurality of nodes and a plurality of interdependencies of a computational graph, such as the two knowledge units 560A and 560B described in FIG. 5C. The plurality of nodes are able to correspond to one or more of the user intent and the one or more project objectives, and the plurality of interdependencies are able to be established between the plurality of nodes based on the plurality of project objective constraints.

In some embodiments, for generating the knowledge units, the system 200A and/or the controller 114 forming a part of the server computing device 102 are able to self-generate one or more of the plurality of data sources based on predictive analysis on the plurality of data sources. For instance, the system 200A is able to analyze one or more historical data sources and current data sources to compute a predictive data source.

In some embodiments, for generating the knowledge units, the system 200A and/or the controller 114 forming a part of the server computing device 102 are able to receive disparate data sets from the disparate data sources 106 and knowledge from the intelligent warehouse 108 and uses polyglot data persistence and retrieval mode to process disparate data sets. Such processed data sets are able to be compared with the user intent and what was already conveyed to the user and provide additive and users interested information in the order of priority for project execution. Once an optimal inference is achieved on the user intent and its implications, then the system 200A sources the same as a knowledge unit which is able to be transmitted to downstream modules, such as the Knowledge Generator 206. In some embodiments, the knowledge assemblies module 512 is able to function as a universal database that is operable to store all the data related to the construction project as the knowledge units.

At step 708, the system 200A and/or the controller 114 forming a part of the server computing device 102 is able to perform a plurality of computational simulations for the user intent based on the knowledge units. Accordingly, a plurality of outputs are able to be generated by a plurality of AI agents/Models used in the plurality of computational simulations, as described by the computational models 520 and 540 in FIG. 5B. Such plurality of outputs are able to be combinatorically analyzed and comparatively evaluated by supervisory algorithms, as described in FIG. 6B. Accordingly, optimal recommendations are able to be generated.

At step 710, the system 200A and/or the controller 114 forming a part of the server computing device 102 are able to generate one or more virtual representations of the AEC smart constructs in a digital environment based on one or more computational simulations from the set of computational simulations. The one or more computational simulations meet a defined criteria associated with the one or more project objectives. The defined criteria associated with the one or more project objectives is able to correspond to, for example, cost, time, material, labor, and sustainability associated with a construction project for which the AEC smart constructs are generated. Examples of the one or more virtual representations of the AEC smart constructs are able to include the visual recommendation 600D (FIG. 6D) of an example building structure, the visual recommendations 600E (FIG. 6E) of an example window panel, the visual recommendations 600F (FIG. 6F) of an example design of a room, the first dashboard 600G (FIG. 6G), and a second dashboard 600H (FIG. 6H).

In some embodiments, the Efficiency Monitor 216 is able to perform efficiency monitoring related to the generated virtual representation of the AEC smart constructs. Monitoring the efficiency is able to result in the system 200A indicating one or more virtual models, amongst the virtual models of the AEC smart constructs, that are cost effective, environment friendly, and time sensitive. Thus, the system 200A provides virtual representations for the AEC smart constructs while simultaneously indicating the best ones that are able to be practically implemented (in an example, best in terms of cost, completion time for implementation and build, environment and the like). In some embodiments, the monitored efficiency of the one or more virtual representations of the AEC smart constructs is able to be presented on a visual display via, for example, the first dashboard 600G (FIG. 6G), and a second dashboard 600H (FIG. 6H), with one or more parameters that are within predefined ranges.

In some embodiments, the Operationalizer 214 is able to virtually operationalize the generated virtual representations of the AEC smart constructs. In other words, the generated virtual representations are analyzed, and their corresponding operation is seen and tested in virtual reality or augmented reality. In some embodiments, the generated virtual representations of the AEC smart constructs are able to be operationalized virtually to facilitate monitoring of the efficiency related to the generated virtual representations of the AEC smart constructs.

In some embodiments, the one or more virtual representations of the AEC smart constructs are able to correspond to one or more recommendations generated based on at least the user input 220, the inferred user intent, the specifications of a facility for which AEC smart constructs are generated, and the defined criteria associated with the one or more project objectives. The one or more recommendations are able to be generated by the recommendation engine 226, as described in FIG. 2B.

The disclosed system 200A provides various advantages. In some embodiments, the system 200A generates the responses to the queries without having to be specifically trained on these queries. In such embodiments, after receiving the user input 220 (in an example, queries) from the user, the system 200A is able to generate responses to the queries based on accrued intelligence augmented by sources (in an example, public sources) from which it is able to correlate. The intelligence that is accrued is able to be one or more of: visual intelligence, spatial intelligence, and data intelligence due to which the system 200A is capable of generating the responses to the queries without having to be specifically trained on these queries.

In some embodiments, the disclosed system 200A is able to leverage one or more existing concepts in AI where a system generates different recommendations (for example, for designs of a construction project) for different scenarios instead of the system being trained to do things. In an example, to build a building structure (whatever the structure may be, such as a two-story building in some place geographical domain with certain parameters), the user simply has to describe the nature of the requirements for the building structure (to be built) with a minimal set of inputs. The system 200A is then able to compose the designs for the type of building structure based at least on the user input 220 and provide multiple design recommendations (as shown in FIG. 6D) for the user to choose from.

In some embodiments, the system 200A is able to analyze one or more of parameters and factor in the one or more of the parameters to provide a fully functional design based on a few simple user inputs. The one or more parameters are able to be, for example, the necessary supplies needed to be procured for the building structure, types of materials required for the building structure, and any other factor related to the building structure. Thus, in some embodiments, the disclosed system 200A infers a user intent and is able to predict physical and tangible artifacts which come up by generating the fully functional design associated with the building structure and presenting such design to the user.

The system 200A is further able to generate the suggestions based on minimal number of inputs and intent describing the user requirements in the form of certain scenarios. In other words, the system 200A is able to simulate optioneering (for one or more elements of a building) to fit the design wishes of the user. For example, the user is able to refer to a building composed at the system 200A and a particular window panel in the building design, and request suggestions that could work for this particular window panel. The disclosed system 200A is able to respond by providing a fully functional and mature design (of the building), for example, the kinds of substructures that would satisfy the user intent and design. The internal processing by the computational system is able to include evaluation of spatial information, geometry of a desired space (for example, factory assembly room), the utilitarian intent of the space, the number of human occupants, the locale governing regulations, and the like. Thus, as illustrated in FIG. 6E, the system 200A provided different recommendations of an example window panel 640 in accordance with some embodiments. The system 200A is further able to refine the proposed designs based on additional user input. The additional user input is able to be in the form of an interactive dialogue with the system 200A and with each user input, the system 200A is able to reconfigure and refine its earlier designs to suit user intent and preferences. On the other hand, if the user requirement associated with a building structure was for a window that would fit a 5 ft×5 ft opening, the conventional system relied on algorithmically written code that would suggest if the window could be a single, double, or multi-panel window. That is, through conventional techniques, the recommendations provided are based in pre-written code based on which suggestions are provided for the window panel. Thus, the disclosed system 200A is capable of generating the suggestions based on minimal number of inputs and intent describing the user requirements in the form of a given scenario.

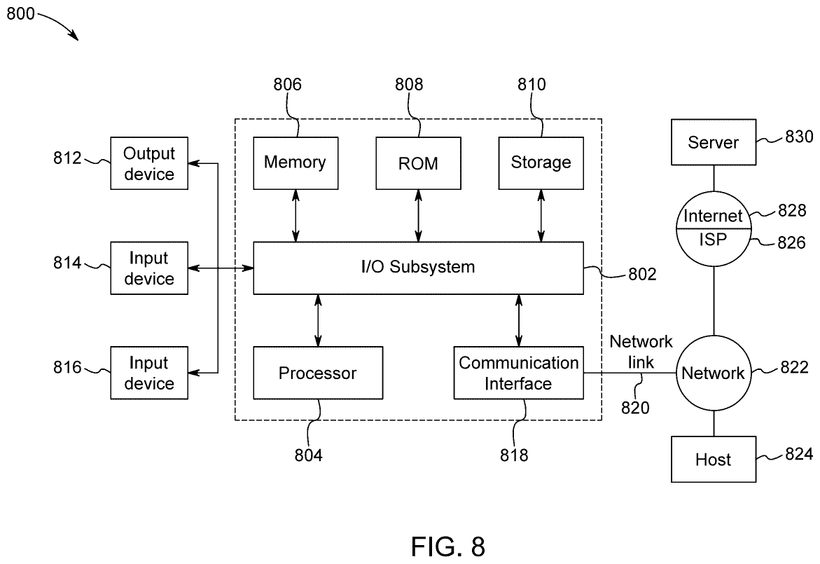

FIG. 8 is a block diagram that illustrates an example computer system according to some embodiments. In the example of FIG. 8, a computer system 800 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

The computer system 800 includes an input/output (I/O) subsystem 802 which is able to include a bus and/or other communication mechanism(s) for communicating information and/or instructions between the components of the computer system 800 over electronic signal paths. The I/O subsystem 802 is able to include an I/O controller, a memory controller and at least one I/O port. The electronic signal paths are represented schematically in the drawings, for example as lines, unidirectional arrows, or bidirectional arrows.

At least one hardware processor 804 is coupled to the I/O subsystem 802 for processing information and instructions. The hardware processor 804 is able to include, for example, a general-purpose microprocessor or microcontroller and/or a special-purpose microprocessor such as an embedded system or a graphics processing unit (GPU) or a digital signal processor or ARM processor. The processor 804 is able to comprise an integrated arithmetic logic unit (ALU) or is able to be coupled to a separate ALU.

The computer system 800 includes one or more units of memory 806, such as a main memory, which is coupled to the I/O subsystem 802 for electronically digitally storing data and instructions to be executed by the processor 804. The memory 806 is able to include volatile memory such as various forms of RAM or other dynamic storage devices. The memory 806 is able to also be used for storing temporary variables or other intermediate information during execution of instructions to be executed by the processor 804. Such instructions, when stored in non-transitory computer-readable storage media accessible to the processor 804, are able to render computer system 800 into a special-purpose machine that is customized to perform the operations specified in the instructions.

The computer system 800 further includes non-volatile memory such as a read only memory (ROM) 808 or other static storage devices coupled to the I/O subsystem 802 for storing information and instructions for the processor 804. The ROM 808 is able to include various forms of programmable ROM (PROM) such as erasable PROM (EPROM) or electrically erasable PROM (EEPROM). A unit of persistent storage 810 is able to include various forms of non-volatile RAM (NVRAM), such as FLASH memory, or solid-state storage, magnetic disk, or optical disk such as CD-ROM or DVD-ROM and is able to be coupled to the I/O subsystem 802 for storing information and instructions. The storage 810 is an example of a non-transitory computer-readable medium that is able to be used to store instructions and data which when executed by the processor 804 cause performing computer-implemented methods to execute the techniques herein.

The instructions in the memory 806, the ROM 808 or the storage 810 are able to comprise one or more sets of instructions that are organized as modules, methods, objects, functions, routines, or calls. The instructions are able to be organized as one or more computer programs, operating system services, or application programs including mobile apps. The instructions are able to comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions are able to implement a web server, web application server or web client. The instructions are able to be organized as a presentation layer, application layer and data storage layer such as a relational database system using structured query language (SQL) or no SQL, an object store, a graph database, a flat file system or other data storage.

The computer system 800 is able to be coupled via I/O subsystem 802 to at least one output device 812. In some embodiments, the output device 812 is a digital computer display. Examples of a display that are able to be used in various embodiments include a touch screen display or a light-emitting diode (LED) display or a liquid crystal display (LCD) or an e-paper display. The computer system 800 is able to include other type(s) of output devices 812, alternatively or in addition to a display device. Examples of other output devices 812 include printers, ticket printers, plotters, projectors, sound cards or video cards, speakers, buzzers or piezoelectric devices or other audible devices, lamps or LED or LCD indicators, haptic devices, actuators, or servos.

At least one input device 814 is coupled to the I/O subsystem 802 for communicating signals, data, command selections or gestures to processor 804. Examples of the input devices 814 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 816, which is able to perform cursor control or other automated control functions such as navigation in a graphical interface on a display screen, alternatively or in addition to input functions. The control device 816 is able to be a touchpad, a mouse, a trackball, or cursor direction keys for communicating direction information and command selections to the processor 804 and for controlling cursor movement on a display. The control device 816 is able to have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 814 is able to include a combination of multiple different input devices, such as a video camera and a depth sensor.

In some embodiments, the computer system 800 is able to comprise an internet of things (IoT) device in which one or more of the output device 812, the input device 814, and the control device 816 are omitted. Or, in such embodiments, the input device 814 is able to comprise one or more cameras, motion detectors, thermometers, microphones, seismic detectors, other sensors or detectors, measurement devices or encoders and the output device 812 is able to comprise a special-purpose display such as a single-line LED or LCD display, one or more indicators, a display panel, a meter, a valve, a solenoid, an actuator or a servo.

When the computer system 800 is a mobile computing device, the input device 814 is able to comprise a global positioning system (GPS) receiver coupled to a GPS module that is capable of triangulating to a plurality of GPS satellites, determining and generating geo-location or position data such as latitude-longitude values for a geophysical location of the computer system 800. The output device 812 is able to include hardware, software, firmware, and interfaces for generating position reporting packets, notifications, pulse or heartbeat signals, or other recurring data transmissions that specify a position of the computer system 800, alone or in combination with other application-specific data, directed toward the host 824 or the server 830.

The computer system 800 is able to implement the techniques described herein using customized hard-wired logic, at least one ASIC or FPGA, firmware and/or program instructions or logic which when loaded and used or executed in combination with the computer system causes or programs the computer system to operate as a special-purpose machine. According to some embodiments, the techniques herein are performed by the computer system 800 in response to the processor 804 executing at least one sequence of at least one instruction contained in the main memory 806. Such instructions are able to be read into the main memory 806 from another storage medium, such as the storage 810. Execution of the sequences of instructions contained in the main memory 806 causes the processor 804 to perform the process steps described herein. In alternative embodiments, hard-wired circuitry is able to be used in place of or in combination with software instructions.

The term “storage media” as used herein refers to any non-transitory media that store data and/or instructions that cause a machine to operate in a specific fashion. Such storage media is able to comprise non-volatile media and/or volatile media. Non-volatile media includes, for example, optical or magnetic disks, such as the storage 810. Volatile media includes dynamic memory, such as the memory 806. Common forms of storage media include, for example, a hard disk, solid state drive, flash drive, magnetic data storage medium, any optical or physical data storage medium, memory chip, or the like.

Storage media is distinct from but is able to be used in conjunction with transmission media. Transmission media participates in transferring information between storage media. For example, transmission media includes coaxial cables, copper wire and fiber optics, including the wires that comprise a bus of the I/O subsystem 802. Transmission media is also able to take the form of acoustic or light waves, such as those generated during radio-wave and infra-red data communications.

Various forms of media are able to be involved in carrying at least one sequence of at least one instruction to the processor 804 for execution. For example, the instructions are able to initially be carried on a magnetic disk or solid-state drive of a remote computer. The remote computer is able to load the instructions into its dynamic memory and send the instructions over a communication link such as a fiber optic or coaxial cable or telephone line using a modem. A modem or router local to the computer system 800 is able to receive the data on the communication link and convert the data to a format that is able to be read by the computer system 800. For instance, a receiver such as a radio frequency antenna or an infrared detector is able to receive the data carried in a wireless or optical signal and appropriate circuitry is able to provide the data to the I/O subsystem 802 such as by placing the data on a bus. The I/O subsystem 802 carries the data to the memory 806, from which the processor 804 retrieves and executes the instructions. The instructions received by the memory 806 are able to optionally be stored on the storage 810 either before or after execution by the processor 804.

The computer system 800 also includes a communication interface 818 coupled to the bus on the I/O subsystem 802. The communication interface 818 provides two-way data communication coupling to the network link(s) 820 that are directly or indirectly coupled to at least one communication network, such as a network 822 or a public or private cloud on the Internet. For example, the communication interface 818 is able to be an Ethernet networking interface, integrated-services digital network (ISDN) card, cable modem, satellite modem, or a modem to provide a data communication coupling to a corresponding type of communications line, for example an Ethernet cable or a metal cable of any kind or a fiber-optic line or a telephone line. The network 822 broadly represents a local area network (LAN), wide-area network (WAN), campus network, internetwork, or any combination thereof. The communication interface 818 is able to comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, the communication interface 818 sends and receives electrical, electromagnetic, or optical signals over signal paths that carry digital data streams representing various types of information.

The network link 820 typically provides electrical, electromagnetic, or optical data communication directly or through at least one network to other data devices, using, for example, satellite, cellular, Wi-Fi, or BLUETOOTH technology. For example, the network link 820 is able to provide a coupling through a network 822 to a host computer, such as a host 824.

Furthermore, the network link 820 is able to provide a coupling through the network 822 to other computing devices via internetworking devices and/or computers that are operated by an Internet Service Provider (ISP) 826. The ISP 826 provides data communication services through a world-wide packet data communication network represented as the Internet 828. The server computer 830 is able to be coupled to the Internet 828. The server 830 broadly represents any computer, data center, virtual machine, or virtual computing instance with or without a hypervisor, or computer executing a containerized program system such as DOCKER or KUBERNETES. The server 830 is able to represent an electronic digital service that is implemented using more than one computer or instance and that is accessed and used by transmitting web services requests, uniform resource locator (URL) strings with parameters in HTTP payloads, API calls, app services calls, or other service calls. The computer system 800 and the server 830 are able to form elements of a distributed computing system that includes other computers, a processing cluster, server farm or other organization of computers that cooperate to perform tasks or execute applications or services. The server 830 is able to comprise one or more sets of instructions that are organized as modules, methods, objects, functions, routines, or calls. The instructions are able to be organized as one or more computer programs, operating system services, or application programs including mobile apps. The instructions are able to comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The server 830 is able to comprise a web application server that hosts a presentation layer, application layer and data storage layer such as a relational database system using structured query language (SQL) or no SQL, an object store, a graph database, a flat file system or other data storage.

The computer system 800 is able to send messages and receive data and instructions, including program code, through the network(s), the network link 820 and the communication interface 818. In the Internet example, a server 830 might transmit a requested code for an application program through the Internet 828, the ISP 826, the local network 822 and the communication interface 818. The received code is able to be executed by the processor 804 as it is received, and/or stored in the storage 810, or other non-volatile storage for later execution.

The execution of instructions as described in this section is able to implement a process in the form of an instance of a computer program that is being executed and consisting of program code and its current activity. Depending on the operating system (OS), a process is able to be composed of multiple threads of execution that execute instructions concurrently. In this context, a computer program is a passive collection of instructions, while a process is able to be the actual execution of those instructions. Several processes are able to be associated with the same program; for example, opening up several instances of the same program often means more than one process is being executed. Multitasking is able to be implemented to allow multiple processes to share the processor 804. While each processor 804 or core of the processor executes a single task at a time, the computer system 800 is able to be programmed to implement multitasking to allow each processor to switch between tasks that are being executed without having to wait for each task to finish. In some embodiments, switches are able to be performed when tasks perform input/output operations, when a task indicates that it can be switched, or on hardware interrupts. Time-sharing is able to be implemented to allow fast response for interactive user applications by rapidly performing context switches to provide the appearance of concurrent execution of multiple processes simultaneously. In some embodiments, for security and reliability, an operating system is able to prevent direct communication between independent processes, providing strictly mediated and controlled inter-process communication functionality.

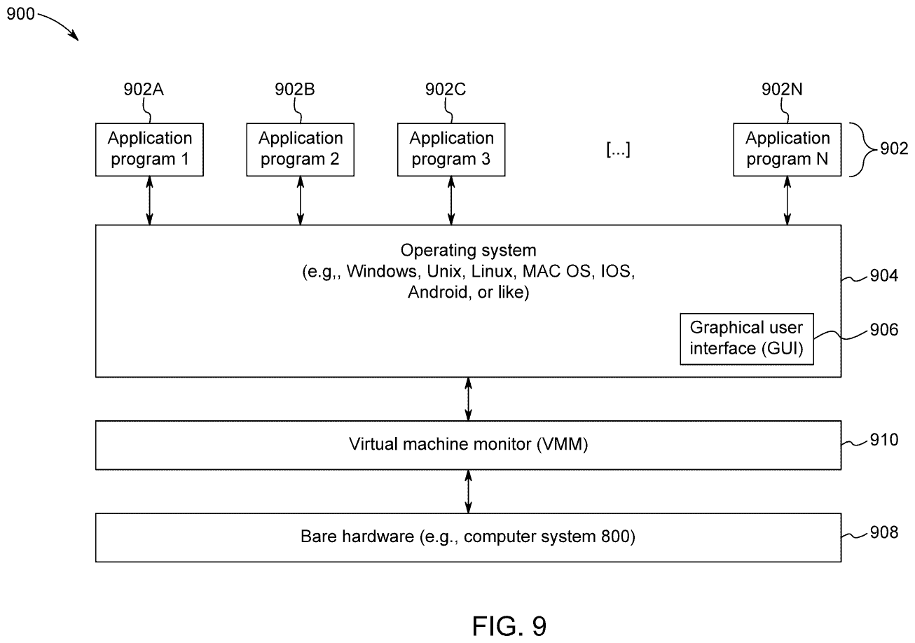

FIG. 9 is a block diagram of a basic software system 900 that is able to be employed for controlling the operation of the computer system 800, according to some embodiments. The software system 900 and its components, including their connections, relationships, and functions, is meant to be for an example only, and not meant to limit implementations of the example embodiment(s). Other software systems suitable for implementing the example embodiment(s) are able to have different components, including components with different connections, relationships, and functions.

The software system 900 is provided for directing the operation of the computer system 800. The software system 900, which is able to be stored in the system memory (RAM) 806 and on the fixed storage 810 (e.g., hard disk or flash memory), includes a kernel or operating system (OS) 904.

The OS 904 manages low-level aspects of computer operation, including managing execution of processes, memory allocation, file input and output (I/O), and device I/O. One or more application programs, represented as 902A, 902B, 902C . . . 902N (collectively, application(s) 902), are able to be “loaded” (e.g., transferred from fixed storage 810 into memory 806) for execution by the software system 900. The applications or other software intended for use on a device are also able to be stored as a set of downloadable computer-executable instructions, for example, for downloading and installation from an Internet location (e.g., a Web server, an app store, or other online service).

The software system 900 includes a graphical user interface (GUI) 906, for receiving user commands and data in a graphical (e.g., “point-and-click” or “touch gesture”) fashion. These inputs, in turn, are able to be acted upon by the software system 900 in accordance with instructions from the OS 904 and/or the application(s) 902. The GUI 906 also serves to display the results of operation from the OS 904 and application(s) 902, whereupon the user is able to supply additional input or terminate the session (e.g., log off).

The OS 904 is able to execute directly on the bare hardware 908 (e.g., processor(s) 804) of the computer system 800. Alternatively, a hypervisor or virtual machine monitor (VMM) 910 is able to be interposed between the bare hardware 908 and the OS 904. In this configuration, the VMM 910 acts as a software “cushion” or virtualization layer between the OS 904 and the bare hardware 908 of the computer system 800.

The VMM 910 instantiates and runs one or more virtual machine instances (“guest machines”). Each guest machine comprises a “guest” operating system, such as the OS 904, and one or more applications, such as the application(s) 902, designed to execute on the guest operating system. The VMM 910 presents the guest operating systems with a virtual operating platform and manages the execution of the guest operating systems.

In some instances, the VMM 910 is able to allow a guest operating system to run as if it is running directly on the bare hardware 908. In these instances, the same version of the guest operating system configured to execute on the bare hardware 908 directly is also able to execute on VMM 910 without modification or reconfiguration. In other words, the VMM 910 is able to provide full hardware and CPU virtualization to a guest operating system in some instances.

In other instances, a guest operating system is able to be specially designed or configured to execute the VMM 910 for efficiency. In these instances, the guest operating system is “aware” that it executes on a virtual machine monitor. In other words, the VMM 910 is able to provide para-virtualization to a guest operating system in some instances.

The above-described basic computer hardware and software is presented for the purpose of illustrating the basic underlying computer components that are able to be employed for implementing the example embodiment(s). The example embodiment(s), however, are not necessarily limited to any particular computing environment or computing device configuration. Instead, the example embodiment(s) are able to be implemented in any type of system architecture or processing environment that one skilled in the art, in light of this disclosure, would understand as capable of supporting the features and functions of the example embodiment(s) presented herein.

In some embodiments, one or more computer-readable storage media are able to be utilized in implementing embodiments consistent with the present disclosure. A computer-readable storage medium refers to any type of physical memory on which information or data readable by a processor is able to be stored. Thus, a computer-readable storage medium is able to store instructions for execution by one or more processors, including instructions for causing the processor(s) to perform steps or stages consistent with the embodiments described herein. The term “computer-readable medium” should be understood to include tangible items and exclude carrier waves and transient signals, for example, be non-transitory. Examples include RAM, ROM, volatile memory, nonvolatile memory, hard drives, CD ROMs, DVDs, flash drives, disks, and any other known physical storage media.

According to some embodiments, the techniques described herein are implemented by at least one computing device. The techniques are able to be implemented in whole or in part using a combination of at least one of the server computing device 102, the client computing device 104, and/or other computing devices that are coupled to the communication network 110 using a network, such as a packet data network. The computing devices are able to be hard-wired to perform the techniques or are able to include digital electronic devices such as at least one ASIC or FPGA that is persistently programmed to perform the techniques or are able to include at least one general purpose hardware processor programmed to perform the techniques pursuant to program instructions in firmware, memory, other storage, or a combination. Such computing devices are also able to combine custom hard-wired logic, ASICs, or FPGAs with custom programming to accomplish the described techniques. The computing devices are able to be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

The terms “comprising,” “including,” and “having,” as used in the claim and specification herein, shall be considered as indicating an open group that is able to include other elements not specified. The terms “a,” “an,” and the singular forms of words shall be taken to include the plural form of the same words, such that the terms mean that one or more of something is provided. The term “one” or “single” is able to be used to indicate that one and only one of something is intended. Similarly, other specific integer values, such as “two,” are able to be used when a specific number of things is intended. The terms “preferably,” “preferred,” “prefer,” “optionally,” “may,” and similar terms are used to indicate that an item, condition, or step being referred to is an optional (not required) feature of the invention.

The claimed invention has been described with reference to various specific and preferred embodiments and techniques. However, it should be understood that many variations and modifications are able to be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this claimed invention. Whenever a range is disclosed, all subranges and individual values are intended to be encompassed. This claimed invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that are able to be individually or together applied to any other embodiment shown or contemplated here to be mixed and matched with the features of such networks, devices, and/or modules.

While the claimed invention has been described with respect to a limited number of embodiments, those skilled in the art, having benefit of this disclosure, will appreciate that other embodiments are able to be devised which do not depart from the scope of the invention as disclosed herein.

We claim:

1. A system for generating virtual representations of architecture, engineering, and construction (AEC) smart constructs, the system comprising:
a controller configured to:
determine user intent based on an analysis of a user input;
determine one or more project objective constraints based on an evaluation of one or more project objectives;
compute knowledge units based on a plurality of nodes and a plurality of interdependencies of a computational graph,
wherein the plurality of nodes corresponds to one or more of the user intent and the one or more project objectives, and
wherein the plurality of interdependencies is established between the plurality of nodes based on the one or more project objective constraints;
perform one or more computational simulations for the user intent based on the knowledge units; and
generate one or more virtual representations of the AEC smart constructs in a digital environment based on the one or more computational simulations,
wherein the one or more computational simulations meet a defined criteria associated with the one or more project objectives.

2. The system of claim 1, wherein the controller is further configured to:
train a machine learning model using training data,
wherein the training data comprises historical data, factual data, and human cognitive factors associated with the user and the AEC smart constructs; and
apply the trained machine learning model to the user input for the determination of the user intent for executing at least one intended task by the user,
wherein the user intent is classified as at least one of: a design intent, a temporal intent, a spatial intent, a geometrical intent, and a cultural intent.

3. The system of claim 2, wherein, to train the machine learning model, the controller is further configured to:
apply one or more logical rules to the user input; and
evaluate and analyze new information based on the application of the one or more logical rules to the user input.

4. The system of claim 1, wherein the controller is further configured to generate a first set of data for the AEC smart constructs based on the determined user intent,
wherein the first set of data comprises taxonomies, intent derivatives, spatial models, geometry computations, temporal computations, and object definitions for the AEC smart constructs.

5. The system of claim 4, wherein the controller is further configured to generate a second set of data for the AEC smart constructs based on the first set of data,
wherein the second set of data comprises objective evaluations, system inputs, correlation maps, sequence compositions, comparative pairings, and knowledge assemblies related to the AEC smart constructs.

6. The system of claim 5, wherein, based on the second set of data, the controller is further configured to generate the one or more virtual representations that corresponds to one or more of a visual composite of a virtual representation, a non-visual composite of the virtual representation, a scenario play and validation of the virtual representation, responses to queries, a human query interface, an operational interface, a speech, a text or a touch gestures, and a computational and physical action.

7. The system of claim 1, wherein the controller is further configured to perform efficiency monitoring related to the generated one or more virtual representations of the AEC smart constructs.

8. The system of claim 7, wherein the controller is further configured to present the monitored efficiency of the one or more virtual representations of the AEC smart constructs on a visual display with one or more parameters that are within predefined ranges.

9. The system of claim 1, wherein the controller is further configured to test operations of the generated one or more virtual representations of the AEC smart constructs in an operational mode in a virtual reality or an augmented reality environment.

10. The system of claim 1, wherein the controller is further configured to generate one or more recommendations based on at least the user input, the determined user intent, specifications of a facility for which AEC smart constructs are generated, and the defined criteria associated with the one or more project objectives,
wherein the defined criteria associated with the one or more project objectives correspond to cost, time, material, labor, and sustainability associated with a construction project for which the AEC smart constructs are generated.

11. A method for generating virtual representations of architecture, engineering, and construction (AEC) smart constructs, the method comprising:
determining user intent based on an analysis of a user input;
determining one or more project objective constraints based on an evaluation of one or more project objectives;
computing knowledge units based on a plurality of nodes and a plurality of interdependencies of a computational graph,
wherein the plurality of nodes corresponds to one or more of the user intent and the one or more project objectives, and
wherein the plurality of interdependencies is established between the plurality of nodes based on the one or more project objective constraints;
performing one or more computational simulations for the user intent based on the knowledge units; and
generating one or more virtual representations of the AEC smart constructs in a digital environment based on the one or more computational simulations,
wherein the one or more computational simulations meet a defined criteria associated with the one or more project objectives.

12. The method of claim 11, further comprising:
training a machine learning model using training data,
wherein the training data comprises historical data, factual data, and human cognitive factors associated with the user and the AEC smart constructs; and
applying the trained machine learning model to the user input for the determination of the user intent for executing at least one intended task by the user,
wherein the user intent is classified as at least one of: a design intent, a temporal intent, a spatial intent, a geometrical intent, and a cultural intent.

13. The method of claim 12, wherein, for training the machine learning model, the method further comprising:
applying one or more logical rules to the user input; and
evaluating and analyzing new information based on the application of the one or more logical rules to the user input.

14. The method of claim 11, further comprising generating a first set of data for the AEC smart constructs based on the determined user intent,
wherein the first set of data comprises taxonomies, intent derivatives, spatial models, geometry computations, temporal computations, and object definitions for the AEC smart constructs.

15. The method of claim 14, further comprising generating a second set of data for the AEC smart constructs based on the first set of data,
wherein the second set of data comprises objective evaluations, system inputs, correlation maps, sequence compositions, comparative pairings, and knowledge assemblies related to the AEC smart constructs.

16. The method of claim 15, wherein, based on the second set of data, the method further comprising generating the one or more virtual representations that corresponds to one or more of a visual composite of a virtual representation, a non-visual composite of the virtual representation, a scenario play and validation of the virtual representation, responses to queries, a human query interface, an operational interface, a speech, a text or a touch gestures, and a computational and physical action.

17. The method of claim 11, further comprising:
performing efficiency monitoring related to the generated one or more virtual representation of the AEC smart constructs; and
presenting the monitored efficiency of the one or more virtual representations of the AEC smart constructs on a visual display with one or more parameters that are within predefined ranges.

18. The method of claim 11, further comprising testing operations of the generated one or more virtual representation of the AEC smart constructs in an operational mode in a virtual reality or an augmented reality environment.

19. The method of claim 11, further comprising generating one or more recommendations based on at least the user input, the determined user intent, specifications of a facility for which AEC smart constructs are generated, and the defined criteria associated with the one or more project objectives,
wherein the defined criteria associated with the one or more project objectives correspond to cost, time, material, labor, and sustainability associated with a construction project for which the AEC smart constructs are generated.

20. A non-transitory computer-readable storage medium, having stored there on a computer-executable program which, when executed by at least one processor, causes the at least one processor to:
determine user intent based on an analysis of a user input;
determine one or more project objective constraints based on an evaluation of one or more project objectives;
compute knowledge units based on a plurality of nodes and a plurality of interdependencies of a computational graph,
wherein the plurality of nodes corresponds to one or more of the user intent and the one or more project objectives, and
wherein the plurality of interdependencies is established between the plurality of nodes based on the one or more project objective constraints;
perform one or more computational simulations for the user intent based on the knowledge units; and
generate one or more virtual representations of AEC smart constructs in a digital environment based on the one or more computational simulations,
wherein the one or more computational simulations meet a defined criteria associated with the one or more project objectives.
